(19) United States
(12) Patent Application Publication
(10) Pub. No.: US 2025/0224225 A1
(43) Pub. Date: Jul. 10, 2025

(54) OPTICAL MEASURING DEVICE, ACQUISITION METHOD, AND RECORDING MEDIUM

(71) Applicant: Mitsubishi Electric Corporation, Tokyo (JP)

(72) Inventors: Nobuki Kotake, Tokyo (JP); Takanori Yamauchi, Tokyo (JP); Hiroki Goto, Tokyo (JP); Masaharu Imaki, Tokyo (JP); Naoki Sono, Tokyo (JP)

(73) Assignee: Mitsubishi Electric Corporation, Tokyo (JP)

(21) Appl. No.: 19/089,779

(22) Filed: Mar. 25, 2025

Related U.S. Application Data
(63) Continuation of application No. PCT/JP2022/042640, filed on Nov. 17, 2022.

(51) Int. Cl. G01B 9/02004; G01B 9/02091; G01B 11/00

(52) U.S. Cl. CPC G01B 9/02004; G01B 9/02091; G01B 11/005

(57) ABSTRACT

An optical measuring device includes: a light source that outputs swept light an irradiation optical system that emits output light for measurement formed with the swept light in a space toward the measurement surface of a measurement target, receives reflected light reflected by the measurement surface of the measurement target, and outputs the reflected light a reference light path that outputs output light for reference formed with the swept light; a measurement information acquiring unit that multiplexes the reflected light for measurement and the reference light, and outputs measurement information obtained by photoelectrically converting the multiplexed interfering light; and an information processing unit that obtains spectrum information by performing Fourier transform on the measurement information corrects the obtained spectrum information using variable factor information, and obtain information about the distance to the measurement surface of the measurement target on the basis of the corrected spectrum information.

### CROSS REFERENCE TO RELATED APPLICATION

This application is a Continuation of PCT International Application No. PCT/JP2022/042640, filed on Nov. 17, 2022, which is hereby expressly incorporated by reference into the present application.

### TECHNICAL FIELD

The present disclosure relates to an optical measuring device.

### BACKGROUND ART

As a method for measuring the distance from a light source to a target using light emitted from the light source, there are known methods such as a pulse propagation method, a triangulation method, a confocal method, a white interference method, and a wavelength scanning interference method.

Among such methods, it is known to use a wavelength scanning interference method as a method capable of performing measurement with higher sensitivity even in a case where the signal strength of light reflected from the target is low.

For example, Patent Literature 1 discloses an optical measuring device that operates as a swept source optical coherence tomography (SS-OCT) device, and is used for biometric measurement.

Patent Literature 1 discloses an optical measuring device that acquires an internal image of the object to be measured with signal light from a light source. In the optical measuring device disclosed in Patent Literature 1, signal light that is output from a wavelength-tunable light source is split into signal light and reference light, the reference light propagates in a reference light processing unit, the signal light enters the object to be measured, and information regarding reflection and scattering from the object to be measured is extracted on the basis of interfering light in which the signal light reflected and scattered by the object to be measured and the reference light interfere with each other. A tomographic image of the object to be measured in a three-dimensional region is acquired using the extracted information.

### CITATION LIST

### Patent Literature

Patent Literature 1: JP 2016-75513 A

### SUMMARY OF INVENTION

### Technical Problem

Patent Literature 1 discloses that “the present invention can also be applied to nonbiological industrial products and the like”, but does not teach any example of specific application to nonbiological industrial products.

For example, when an optical measuring device of a SS-OCT system is used in a processing apparatus that has a workpiece as a measurement target, there is a variable factor for a measured distance on the measurement surface of the measurement target due to a difference in the measurement target or a state of the measurement surface of the measurement target, and, because of this variable factor, the intensity of light reflected from the measurement surface of the measurement target is not necessarily highly accurate in the measurement of the measured distance.

Therefore, when the light reflected from the measurement surface of the measurement target is used as the reflected light for measurement without any change, an error is observed in the measured distance.

The present disclosure has been made in view of the above points, and aims to provide an optical measuring device of a wavelength scanning interference type that is an optical measuring device capable of measuring the distance to the measurement surface of a measurement target with high accuracy even when there is a variable factor for a measured distance on the measurement surface of the measurement target.

### Solution to Problem

An optical measuring device according to the present disclosure includes: a wavelength-swept light source to output swept light whose wavelength continuously changes with time; an irradiation optical system to emit output light for measurement formed with the swept light from the wavelength-swept light source as measurement light in a space toward a measurement surface of a measurement target, receive reflected light of the measurement light reflected by the measurement surface of the measurement target, and output the reflected light as reflected light for measurement; a reference light path to output output light for reference as reference light formed with the swept light from the wavelength-swept light source; a measurement information acquirer to multiplex the reflected light for measurement from the irradiation optical system and the reference light from the reference light path, and output measurement information obtained by photoelectrically converting the multiplexed interfering light; and an information processor including: a spectrum acquirer to obtain spectrum information by performing Fourier transform on the measurement information from the measurement information acquirer; a denoising processor to compare a denoising threshold with a value of the spectrum information obtained by the spectrum acquirer and obtain the spectrum information from which a noise is removed; a second spectrum information corrector to obtain the spectrum information from which a variation value of a distance depending on a step of the measurement target using a correction coefficient whose ratio of an under surface to a upper surface forming the step having a height difference at an measurement surface of the measurement target, is larger than 1 is removed from the spectrum information obtained by the denoising processor; a second spectrum information selector to obtain the spectrum information indicating a second peak value which is a different spectrum information from the spectrum information indicating a first peak value which is a highest peak value in the spectrum information obtained by the denoising processor for the spectrum information obtained by the second spectrum information corrector; a distance information acquirer to obtain as an additional information indicating the step at the measurement surface of the measurement target, a emitting position of the measurement light from the irradiation optical system, the difference between the first peak value and the second peak value indicated by the spectrum information selected by the second spectrum information selector indicating minimum; and an outputter to output the additional information indicating a position of the step at the measurement surface of the measurement target obtained by the distance information acquirer.

### Advantageous Effects of Invention

According to the present disclosure, an optical measuring device of a wavelength scanning interference type can detect a step in higher resolution than space resolution determined by a spot diameter of the measurement light from irradiation optical system and identify a position of an edge at the measurement surface of a measurement target with high accuracy.

### BRIEF DESCRIPTION OF DRAWINGS

FIG. 1 is a configuration diagram illustrating an optical measuring device according to a first embodiment.

FIG. 2 is a configuration diagram illustrating an information processing unit in the optical measuring device according to the first embodiment.

FIG. 3 is a schematic diagram illustrating a relationship between an optical head and the measurement surface of a measurement target at three positions.

FIG. 4 is a schematic diagram illustrating a relationship between reflected light for measurement and reference light, and the intensity of interfering light formed with an analog signal photoelectrically converted by a measurement information acquiring unit 5.

FIG. 5 is a schematic diagram illustrating the spectrums based on the beat frequencies corresponding to the measurement surface of the measurement target at the three positions.

FIG. 6 is a conceptual diagram illustrating the optical head, the measurement surface of the measurement target, and measurement light at a step position in a case where there is a step on the measurement surface of the measurement target.

FIG. 7 is a diagram conceptually illustrating the intensity of reflected light with respect to the distance from the irradiation surface of the optical head.

FIG. 8 is a conceptual diagram illustrating the optical head, the measurement surface of a measurement target, and the measurement light in a case where oil adheres to the measurement surface of the measurement target.

FIG. 9 is a diagram conceptually illustrating the intensity of the reflected light corresponding to the intensity of the reflected light with respect to the distance from the irradiation surface of the optical head in a case where spectrum information corrected by a first spectrum information correcting unit is obtained.

FIG. 10 is a reference diagram illustrating changes in spectrum intensity in the vicinity of the position of a boundary (edge) of a stepped portion having a height difference.

FIG. 11 is a diagram illustrating changes in spectrum intensity in the vicinity of the position of a boundary (edge) of a stepped portion having a height difference in the optical measuring device according to the first embodiment.

FIG. 12 is a diagram illustrating the hardware configuration of the information processing unit in the optical measuring device according to the first embodiment.

FIG. 13 is a flowchart illustrating operations to be performed by the information processing unit in the optical measuring device according to the first embodiment.

FIG. 14 is a diagram illustrating the intensity of the spectrum after each step in the information processing unit in the optical measuring device according to the first embodiment, in a case where oil adheres to the measurement surface of the measurement target.

FIG. 15 is a diagram illustrating the intensity of the spectrum after each step in the information processing unit in the optical measuring device according to the first embodiment, in a case where there is a step on the measurement surface of the measurement target.

FIG. 16 is a configuration diagram illustrating an optical measuring device according to a second embodiment.

### DESCRIPTION OF EMBODIMENTS

### First Embodiment

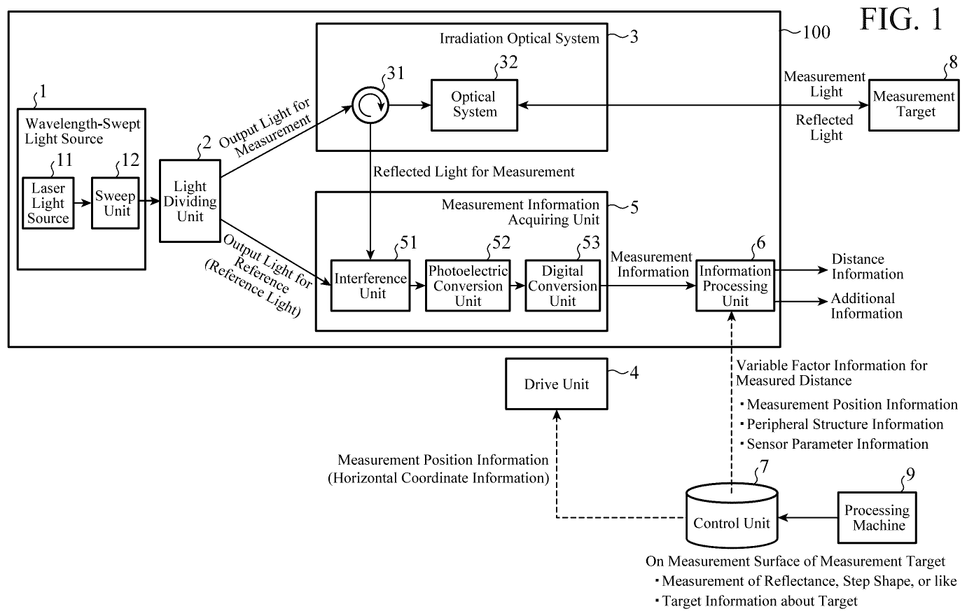

An optical measuring device according to a first embodiment is described with reference to FIGS. 1 to 15.

The optical measuring device according to the first embodiment is an optical measuring device of a wavelength scanning interference type that uses a swept source optical coherence tomography (SS-OCT) that operates as a laser radar device.

The optical measuring device according to the first embodiment cooperates with a processing machine (automatic stage), and functions as an optical distance measurement device that measures a distance to a measurement surface of a measurement target 8 that is a workpiece.

The optical measuring device according to the first embodiment can measure the distance to the measurement surface of the measurement target with high accuracy, even if there is a variable factor with respect to the measurement distance on the measurement surface of the measurement target.

Examples of variable factors with respect to the measurement distance include those listed below.

1. Sensor parameters. When an optical measuring device of a SS-OCT is used, the reception band is widened to achieve a wider measurement range, and false signal noises such as harmonics and side lobes due to resampling performed on the principle of the SS-OCT are generated.

2. Parameters depending on the distance to the measurement surface of the measurement target 8. The transmission power of a wavelength-swept light source 1, a frequency of a wavelength within a sweep range from the wavelength-swept light source 1, the aperture diameter of a lens in an irradiation optical system 3, the light-condensing distance in the irradiation optical system 3, and the like.

The items 1 and 2 are variable factors caused by characteristics parameters mainly indicating optical characteristics of the irradiation optical system 3.

3. A difference in material of the measurement target. Differences in reflectance and transmittance of the measurement surfaces of different measurement targets 8. This is a variable factor due to a difference in material of the measurement target.

Note that the reflectance is the ratio of the reception power of the irradiation optical system 3 that has received light reflected from the measurement surface of the measurement target 8 to the transmission power of measurement light from the irradiation optical system 3.

Meanwhile, the transmittance is the transmittance of an adhering substance when the adhering substance adheres to the measurement surface of the measurement target 8.

4. The state of the measurement surface of the measurement target.
1) An adhering substance on the measurement surface of the measurement target 8. For example, the thickness of an oil film 8A in the oil adhering to the measurement surface of the measurement target 8 is a variable factor. Also, if moisture adheres to the measurement surface of the measurement target 8, the thickness of the moisture is a variable factor.
2) The shape of a step or the like on the measurement surface of the measurement target 8. For example, the step is a variable factor.

The items 3 and 4 are variable factors due to the material of the measurement target 8, an adhering substance on the measurement surface, and a peripheral structure indicating the shape of a step or the like on the measurement surface.

When a variable factor due to a characteristics parameter indicating optical characteristics of the irradiation optical system 3 is present as a variable factor for measurement of the distance to the measurement surface of the measurement target 8, the optical measuring device according to the first embodiment obtains information about the distance to the measurement surface of the measurement target 8, by obtaining, with an information processing unit 6, spectrum information from which the amount of variation in the distance depending on the irradiation optical system 3 has been eliminated, using information regarding the characteristics parameters.

In the first embodiment, the characteristics parameters indicating the optical characteristics of the irradiation optical system 3 as variable factor information include a frequency of a wavelength within the sweep range from the wavelength-swept light source 1, the aperture diameter of a lens in the irradiation optical system 3, and the light-condensing distance in the irradiation optical system 3.

When a variable factor due to a peripheral structure around the measurement target 8 is present as a variable factor for measurement of the distance to the measurement surface of the measurement target 8, the optical measuring device according to the first embodiment obtains information about the distance to the measurement surface of the measurement target 8, by obtaining, with the information processing unit 6, spectrum information from which the amount of variation in the distance depending on the peripheral structure around the measurement target 8 has been eliminated, using information regarding the peripheral structure around the measurement target 8.

In the first embodiment, parameters indicating variable factor information regarding a peripheral structure around the measurement target 8 include the transmittance (dissipation factor) on the measurement surface when an adhering substance is present on the measurement surface of the measurement target 8, and the reception power of light reflected from the measurement surface when a step exists on the measurement surface of the measurement target 8.

When the oil film 8A as an adhering substance on the measurement surface of the measurement target is present as a variable factor due to a peripheral structure around the measurement target 8, the optical measuring device according to the first embodiment obtains, with the information processing unit 6, information about the distance to the measurement surface of the measurement target 8, information about the thickness of the oil film 8A having been subtracted from the information. When moisture is present as an adhering substance on the measurement surface of the measurement target, the information processing unit 6 obtains information about the distance to the measurement surface of the measurement target 8 from which information about the thickness of the moisture has been subtracted.

In the optical measuring device according to the first embodiment, when a step on the measurement surface of the measurement target is present as a variable factor due to a peripheral structure around the measurement target 8, the information processing unit 6 further obtains additional information indicating the position of the step with high accuracy.

As illustrated in FIG. 1, the optical measuring device according to the first embodiment includes the wavelength-swept light source 1, a light dividing unit 2, the irradiation optical system 3, a measurement information acquiring unit 5, the information processing unit 6, and a control unit 7.

The wavelength-swept light source 1, the light dividing unit 2, the irradiation optical system 3, and the measurement information acquiring unit 5 are included in an optical head 100. The information processing unit 6 may also be included in the optical head 100.

The wavelength-swept light source 1, the light dividing unit 2, the irradiation optical system 3, the measurement information acquiring unit 5, and the information processing unit 6 function as a distance measuring device.

The optical measuring device according to the first embodiment obtains a spectrum in the horizontal direction on the measurement surface of the measurement target 8 obtained on the basis of the interfering light between the reflected light for measurement that has been output from the wavelength-swept light source 1 and been reflected by the measurement surface of the measurement target 8, and the reference light output from the wavelength-swept light source 1, and corrects the obtained spectrum with correction information based on characteristics parameters indicating optical characteristics of the irradiation optical system 3, which are variable factors related to the measured distance. By doing so, the optical measuring device can eliminate false signal noises, and measure the distance to the measurement surface of the measurement target with high accuracy.

The optical measuring device according to the first embodiment can accurately perform at least one of a measurement of the thickness of the oil film 8A of the oil adhering to the measurement surface of the measurement target, and a measurement of the accurate position of a step on the measurement surface in the measurement target having the step on the measurement surface.

Note that a step means a boundary (an edge) of a stepped portion having a height difference on the measurement surface of the measurement target, and not only a boundary formed with a step of 90 degrees between an upper surface (higher surface) and the under surface (lower surface), but also a case where the upper surface and the under surface are continuous in a tapered shape is included as a boundary.

In short, in the present case, a boundary (an edge) of a step having a height difference includes a partition line whose height starts changing on the measurement surface of the measurement target 8, and the position of the boundary is referred to as the position of the edge.

Hereinafter, a boundary of a step having a height difference will be referred to as an edge.

The optical measuring device according to the first embodiment cooperates with the optical head 100, or, in particularly, with a drive unit 4 that moves the irradiation optical system 3 and the measurement target 8 relatively in the horizontal direction, and acquires a spectrum peak in the horizontal direction on the measurement surface of the measurement target 8.

In the first embodiment, the drive unit 4 moves the irradiation surface of the irradiation optical system 3 spatially in the optical head 100, and changes the position of the spot of the measurement light emitted from the irradiation surface of the irradiation optical system 3, which is the measurement position. The spatial movement of the irradiation optical system 3 is in the horizontal direction, which includes the X-axis direction and the Y-axis direction, and in the vertical direction, which is the Z-axis direction.

The wavelength-swept light source 1 includes a laser light source 11 and a sweep unit 12, and the sweep unit 12 continuously changes the wavelength of laser light of a single frequency from the laser light source 11 with respect to time within the sweep range, and outputs (emits) swept light that is laser light subjected to wavelength sweep.

The wavelength sweep by the sweep unit may use a method for simultaneously sweeping a plurality of wavelengths like TROSA used in optical information communication.

The swept light is desirably swept linearly with respect to time, and the time and the wavelength are desirably in a 1:1 relationship.

Note that, even if the sweep for the swept light is nonlinear with respect to time, the nonlinearity may be compensated for by the measurement information acquiring unit 5 and the information processing unit 6. As for the technique for compensating for nonlinearity, a generally known technique may be used.

The wavelength-swept light source 1 continuously changes the wavelength within the sweep range with respect to time, and repeatedly emits swept light that is wavelength-swept laser light, such as swept light having a center wavelength of 1550 nm and a sweep range of 100 nm.

The laser light source 11 in the wavelength-swept light source 1 is a semiconductor laser (a laser diode: LD).

The sweep unit 12 in the wavelength-swept light source 1 is a wavelength-swept or voltage-controlled transmitting device of a Littman type or a Littrow type using a scanner mirror.

The light dividing unit 2 receives the swept light from the wavelength-swept light source 1 via optical fibers, and divides the light into output light for measurement and output light for reference. The division ratio between the output light for measurement and the output light for reference is set in accordance with various conditions, but it is desirable to set a high division ratio for the output light for measurement so that the measurement target 8 can be measured even if the measurement target 8 has a low reflectance.

In the first embodiment, the power of light is divided at the ratio between the output light for measurement and the output light for reference=8:2, on the basis of the division ratio determined based on the design of network calculation or the like.

The light dividing unit 2 is a coupler that is a 1×2 fiber directional coupler.

The optical fibers are single-mode fibers that are widely used. The optical fibers connecting the components described below are also single-mode fibers.

The optical fiber that connects the light dividing unit 2 and the measurement information acquiring unit 5 forms a reference light path that outputs, as reference light, the output light for reference formed with the swept light from the wavelength-swept light source 1.

The irradiation optical system 3 receives the output light for measurement from the light dividing unit 2 via an optical fiber, emits the output light for measurement as measurement light in a space toward the measurement surface of the measurement target 8, receives reflected light obtained by the measurement surface of the measurement target 8 reflecting the measurement light, and outputs the reflected light to the measurement information acquiring unit 5 as reflected light for measurement.

The irradiation optical system 3 includes an optical circulator 31 and an optical system 32. The optical system 32 includes a condenser lens such as a collimator lens and a connector.

The irradiation optical system 3 has a function of transmitting the output light for measurement to the optical system 32 with the optical circulator 31, and transmitting the reflected light for measurement from the optical system 32 to the measurement information acquiring unit 5, a function of condensing, as the measurement light, the output light for measurement generated by the optical system 32 onto the measurement surface of the measurement target 8, and a function of condensing, as the reflected light for measurement, the reflected light from the measurement surface of the measurement target 8 onto the measurement information acquiring unit 5.

The optical circulator 31 outputs the output light for measurement from the light dividing unit 2 as the measurement light to the condenser lens, and the condenser lens receives the reflected light obtained by the measurement surface of the measurement target 8 reflecting the measurement light, and outputs the reflected light as the reflected light for measurement to the measurement information acquiring unit 5. That is, the optical circulator separates the output light for measurement and the reflected light for measurement from each other.

The optical system 32 performs beam formation for irradiating the measurement surface of the measurement target 8 with the output light for measurement, emits the resultant light as the measurement light, receives scattered light reflected from the measurement surface of the measurement target 8 as the reflected light, performs beam formation, and outputs the received reflected light as the reflected light for measurement. That is, the optical system 32 corresponds to a telescope having a lens for changing characteristics of light.

The optical circulator 31 and the light dividing unit 2 are connected by an optical fiber, and the optical circulator and the measurement information acquiring unit 5 are connected by an optical fiber.

The output light for measurement from the optical circulator 31 is guided to the condenser lens in the optical system 32 by the optical fiber, and the measurement light that has been condensed by the condenser lens and been subjected to the beam formation is emitted in the space from an end surface of the connector in the optical system 32 located at one end of the optical fiber toward the measurement target 8 via the optical fiber.

The reflected light, which is scattered light obtained by the measurement target 8 reflecting the measurement light, is incident on the end surface of the connector, and is output to the measurement information acquiring unit 5 as the reflected light for measurement by the optical circulator via the optical fiber.

In a case where there is a step on the measurement surface of the measurement target 8, to obtain a sufficiently high light intensity of the reflected light from the measurement target 8, the focal point of the condenser lens for emitting the measurement light in the space toward the measurement target 8 is desirably set in the highest horizontal plane on the measurement surface.

Further, in a case where oil adheres to the measurement surface of measurement target 8, to obtain a sufficiently high light intensity of the reflected light from the measurement target 8, the focal point of the condenser lens for emitting the measurement light in the space toward the measurement target 8 is desirably set in the oil surface of the oil adhering to the measurement surface.

The diameter of the spot formed on the measurement surface of the measurement target 8 by the measurement light from the irradiation optical system 3 has a finite value, and cannot be made infinitely small.

The intensity distribution of light within the diameter of a spot formed by the measurement light is generally normally distributed, and is a point-symmetric intensity distribution with respect to the optical axis, having a Gaussian spread around the optical axis (center point) of the measurement light.

Either the optical head 100 including the irradiation optical system 3 or the measurement target 8 is relatively moved in the horizontal direction by the drive unit 4, and the irradiation point formed on the measurement surface of the measurement target 8 by the measurement light from the irradiation optical system 3, which is the spot, linearly moves on the measurement surface of the measurement target 8.

The scanning method and the measurement pitch for relatively moving either the optical head 100 or the measurement target 8 in the horizontal direction are stored as a table in the control unit 7, and the scanning method and the measurement pitch from the control unit 7 are input to the drive unit 4, so that the drive unit 4 moves either the optical head 100 or the measurement target 8 in the horizontal direction.

The scanning method and the measurement pitch are set by the user through a user interface (IF), and are stored into the control unit 7 as a table.

Note that the relative movement in the horizontal direction of either the optical head 100 or the measurement target 8 by the drive unit 4 may not be performed by the scanning method and with the measurement pitch stored in the control unit 7. Instead, a camera may be mounted on the control unit 7, the control unit 7 may automatically select an irradiation point on the measurement surface of the measurement target 8 from an optical image of the measurement surface of the measurement target 8 captured by the camera, and the drive unit 4 may be controlled to move either the optical head 100 or the measurement target 8 to the selected position.

Horizontal coordinate information including digital information indicating the horizontal coordinates, which are the X-coordinate and the Y-coordinate, of the irradiation point on the measurement surface of the measurement target 8 is determined by an initial value input from the control unit 7, the scanning method, and the measurement pitch, the horizontal coordinate information about the irradiation point and the emission timing of the swept light from the wavelength-swept light source 1 are synchronized, and the horizontal coordinates of the measurement light formed with the swept light from the wavelength-swept light source 1 and the irradiation point on the measurement surface of the measurement target 8 are identified.

Note that, in the case where an irradiation point is automatically selected from an optical image captured by the camera, the horizontal coordinate information about the irradiation point and the emission timing of the swept light from the wavelength-swept light source 1 are also synchronized, and the horizontal coordinates of the measurement light formed with the swept light from the wavelength-swept light source 1 and the irradiation point on the measurement surface of the measurement target 8 are identified.

In a case where the position of the measurement target 8 is fixed, the optical head 100 including the irradiation optical system 3 is provided in the drive unit 4, and the optical head 100 is moved in the horizontal direction by the drive unit 4, the optical head 100 is scanned by raster scan or the like by the horizontal movement of the optical head.

The scanning method and the measurement pitch implemented by the drive unit 4 are controlled by the control unit 7, and the horizontal coordinates at which the irradiation point formed on the measurement surface of the measurement target 8 by the measurement light from the irradiation optical system 3 is located are output to the control unit 7 as the horizontal coordinate information, under the control of the control unit 7.

Further, in the case where the position of the optical head 100 including the irradiation optical system 3 is fixed, the measurement target 8 is placed in the drive unit 4, and the measurement target 8 is moved in the horizontal direction by the drive unit 4, the measurement target 8 is scanned by raster scan or the like performed by horizontal movement of the table on which the measurement target 8 is placed.

The scanning method and the measurement pitch implemented by the drive unit 4 are controlled by the control unit 7, and the horizontal coordinates at which the irradiation point formed on the measurement surface of the measurement target 8 by the measurement light from the irradiation optical system 3 is located are output to the control unit 7 as the horizontal coordinate information, under the control of the control unit 7.

The drive unit 4 includes a servomotor and a drive mechanism that converts rotational force of the servomotor into movement in the horizontal direction.

To focus the measurement light from the irradiation optical system 3 onto the irradiation point on the measurement surface of the measurement target 8, the drive unit 4 includes the servomotor that relatively moves either the optical head 100 including the irradiation optical system 3 or the measurement target 8 in the vertical direction, and the drive mechanism that converts the rotational force of the servomotor into movement in the vertical direction.

The drive unit 4 outputs vertical coordinate information including digital information indicating the Z-coordinate to the information processing unit 6.

Further, the relative movement of the optical head 100 and the measurement target 8 in the horizontal direction is not limited to direct movement of the optical head 100 or the measurement target 8. Instead, a galvanometer mirror may be used, and one-dimensional scan may be performed on the galvanometer mirror, to spatially scan the measurement light from the irradiation optical system 3.

In this case, the drive unit that drives the galvanometer mirror is also controlled by the control unit 7, and the horizontal coordinates at which the irradiation point formed on the measurement surface of the measurement target 8 by the measurement light from the irradiation optical system 3 is located are output to the control unit 7 as the horizontal coordinate information, under the control of the control unit 7.

Furthermore, the relative movement of the irradiation optical system 3 and the measurement target 8 may be such that the irradiation optical system 3 has a plurality of emission end surfaces from which the measurement light is emitted in a horizontal plane, and the emission end surfaces from which the measurement light is emitted are switched to horizontally move the irradiation point of the measurement light from the irradiation optical system 3 on the measurement surface of the measurement target 8.

In this case, the drive unit that switches the plurality of emission end surfaces is also controlled by the control unit 7, and the horizontal coordinates at which the irradiation point formed on the measurement surface of the measurement target 8 by the measurement light from the irradiation optical system 3 is located are output to the control unit 7 as the horizontal coordinate information, under the control of the control unit 7.

The measurement information acquiring unit 5 multiplexes the reflected light for measurement from the irradiation optical system 3 and the reference light (the output light for reference) from the light dividing unit 2 corresponding to the reflected light for measurement, in synchronization with each emission of the swept light subjected to wavelength sweep within the sweep range from the wavelength-swept light source 1, and outputs measurement information obtained by photoelectrically converting the multiplexed interfering light.

The measurement information acquiring unit 5 includes: an interference unit 51 that multiplexes the reflected light for measurement and the output light for reference; a photoelectric conversion unit 52 that photoelectrically converts the interfering light multiplexed by the interference unit 51; and a digital conversion unit 53 that converts the analog signal from the photoelectric conversion unit 52 into a digital signal, and outputs the digital signal as the measurement information.

The interference unit 51 is an optical coupler such as a fused coupler.

The photoelectric conversion unit 52 performs photoelectric conversion by performing detection by heterodyne, using a balanced receiver that is an optical-electrical conversion module of a differential amplification type. Note that a single light receiving element that is a photodetector may be used.

The digital conversion unit 53 is an analog-to-digital converter (AD converter).

The information processing unit 6 performs fast Fourier transform (FFT) on the measurement information from the measurement information acquiring unit 5 in synchronization with the horizontal coordinate information from the drive unit 4, and obtains the distance to the measurement surface of the measurement target 8 from the frequency at the spectrum peak at the irradiation point on the measurement surface of the measurement target 8, the irradiation point being indicated by the horizontal coordinate information.

Specifically, the measurement information obtained from the measurement information acquiring unit 5 by the interfering light between the reflected light for measurement and the reference light is subjected to Fourier transform to obtain the beat frequency of the spectrum, and the information processing unit 6 obtains the distance to the measurement surface of the measurement target 8, taking advantage of the fact that the beat frequency is proportional to the difference in optical path length between the reflected light for measurement and the reference light.

As the beat frequency is proportional to the optical path length, which is the product of the length and the refractive index of the optical propagation medium including the optical fiber, the beat frequency of the spectrum is obtained, so that the distance to the measurement surface of the measurement target 8 can be obtained.

On the other hand, the intensity of the beat frequency of the spectrum is proportional to the product of the intensity of the reflected light for measurement and the intensity of the reference light. Further, the intensity of the reflected light for measurement changes depending on the reflectance on the measurement surface of the measurement target 8, the position of the reflection point (the irradiation point of the measurement light) in the height direction and the area of the spot at the reflection point, scattering of the reflected light, and the like.

Assuming that the reflectance on the measurement surface of the measurement target 8 and the scattering of the reflected light are uniform on the measurement surface, the intensity of the reflected light for measurement changes depending on the position of the reflection point (the irradiation point of the measurement light) in the height direction and the area of the spot at the reflection point.

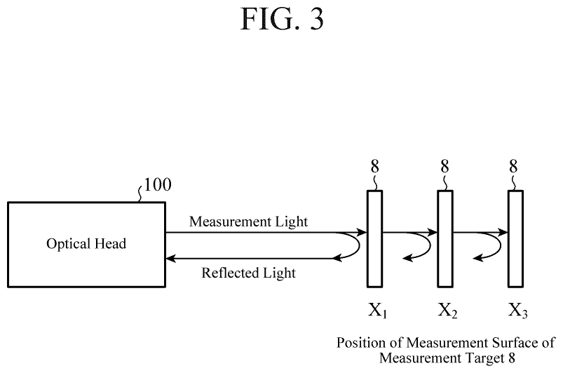

As illustrated in FIG. 3, it is now assumed that, at each of the three stages of distances X1 to X3 from the irradiation surface of the optical head 100 to the position of the measurement surface of the measurement target 8, the measurement light is emitted from the irradiation optical system 3 onto the measurement surface of the measurement target 8 every time the swept light from the wavelength-swept light source 1 is scanned once, or every time the swept light within the sweep range is emitted, and the irradiation optical system 3 receives the reflected light from the measurement surface of the measurement target 8.

At this point of time, it is assumed that there are no false signal noises generated by resampling or the like due to a variable factor for a measured distance with characteristics parameters indicating optical characteristics of the irradiation optical system 3.

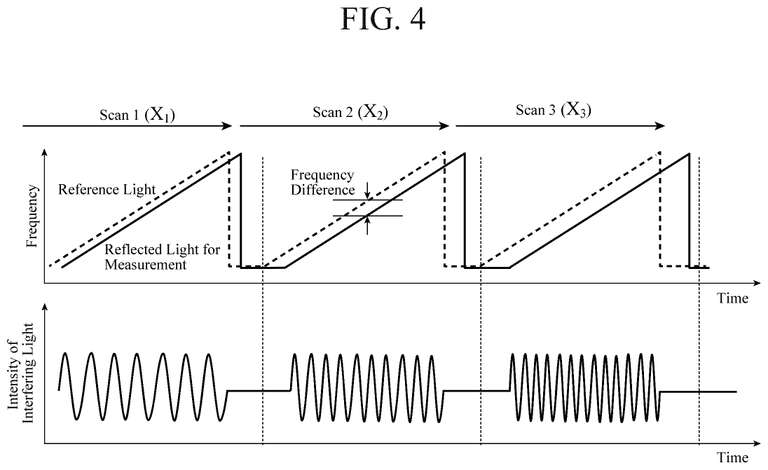

As illustrated in FIG. 4, when the reflected light for measurement and the reference light corresponding to the respective distances X1 to X3 to the position of the measurement surface of the measurement target 8 are input to the interference unit 51 of the measurement information acquiring unit 5, interfering light corresponding to the respective distances X1 to X3 and corresponding to the frequency difference between the input reflected light for measurement and the reference light is obtained, and the intensity of the interfering light formed with a photoelectrically converted analog signal is obtained from the photoelectric conversion unit 52 of the measurement information acquiring unit 5.

The frequency difference between the input reflected light for measurement and the input reference light corresponds to the difference in time of arrival until the swept light emitted from the wavelength-swept light source 1 is input to the measurement information acquiring unit 5 as the reflected light for measurement and the reference light, and corresponds to the difference in optical path length between the optical path through which the swept light reaches the measurement information acquiring unit 5 as the reflected light for measurement and the optical path through which the swept light reaches the measurement information acquiring unit 5 as the reference light.

The intensity of the interfering light varies depending on the frequency difference between the input reflected light for measurement and the input reference light, which is the difference in optical path length.

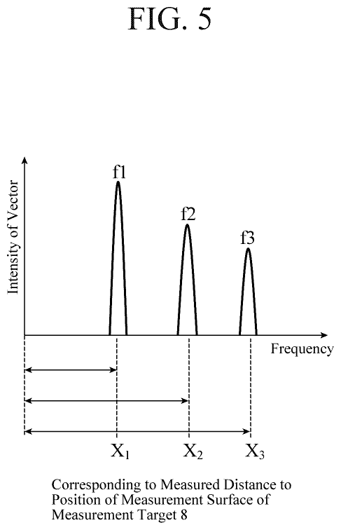

The analog signal obtained by the photoelectric conversion unit 52 is converted into a digital signal by the digital conversion unit 53, and is subjected to Fourier transform, so that a spectrum based on the beat frequency is obtained as illustrated in FIG. 5.

Since the beat frequency is proportional to the difference in optical path length between the reflected light for measurement and the reference light, the beat frequency corresponds to the measurement distance to the measurement surface of the measurement target 8, and the distance to the measurement surface of the measurement target 8 can be obtained.

Accordingly, the distance d to the measurement surface of the measurement target 8 can be expressed as in the following Expression (1).

$$d = {λ}_{c}^{2} \cdot Δ f / 2 {V}_{0} \qquad ( 1 )$$

Note that, in Expression (1), λc represents the center frequency of the wavelength in the sweep range in the swept light, Δf represents the frequency difference corresponding to the peak of the spectrum, and V₀ represents the sweep velocity.

As can be seen from Expression (1), the center frequency λc and the sweep velocity V₀ of the swept light are fixed, so that the distance d to the measurement surface of the measurement target 8 becomes proportional to the frequency difference Δf. Thus, it is possible to know the distance d by obtaining the frequency difference Δf.

Further, the intensity of the spectrum becomes lower as the distance to the measurement surface of the measurement target 8 becomes longer.

Therefore, there is a possibility that the distance to the measurement surface of the measurement target 8 at a position far from the optical head 100 cannot be measured due to variable factors related to the measured distance due to variable factors such as a characteristics parameter indicating optical characteristics of the irradiation optical system 3, an adhering substance on the measurement surface, and a step on the measurement surface.

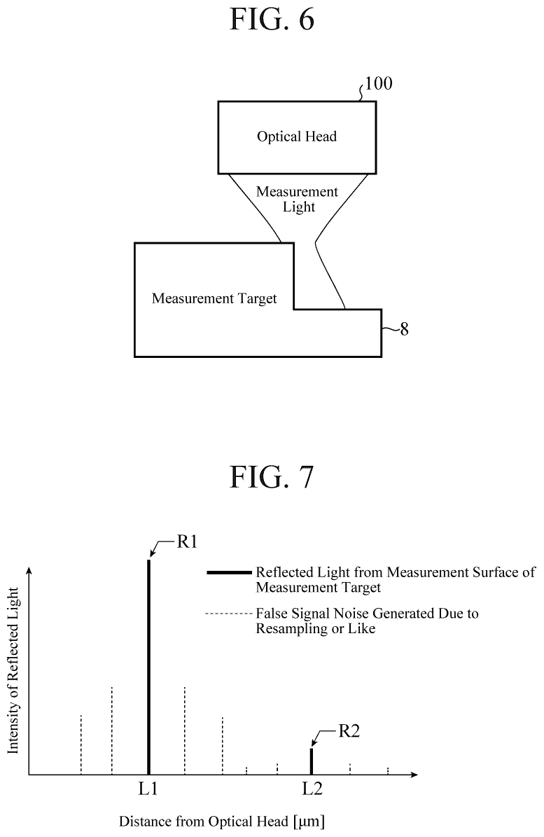

For example, as illustrated in FIG. 6, it is assumed that a step having a height difference between the upper surface and the under surface is formed on the measurement surface of the measurement target 8, and a spot formed by the measurement light from the irradiation optical system 3 is at the position of the step on the measurement surface, which is the position of an edge. At this point of time, the focal point of the measurement light from the irradiation optical system 3 is set on the upper surface of the measurement surface of the measurement target 8.

The intensity of the reflected light obtained from the measurement surface of the measurement target 8 at this point of time is conceptually illustrated in FIG. 7.

FIG. 7 illustrates the intensity of the reflected light with respect to the distance from the irradiation surface of the optical head 100.

In FIG. 7, a solid line R1 indicates the intensity by the light reflected from the upper surface of the measurement surface, a solid line R2 indicates the intensity by the light reflected from the under surface of the measurement surface, and dashed lines indicate the intensities of reflected light caused by harmonic waves due to resampling and false signal noises such as side lobes.

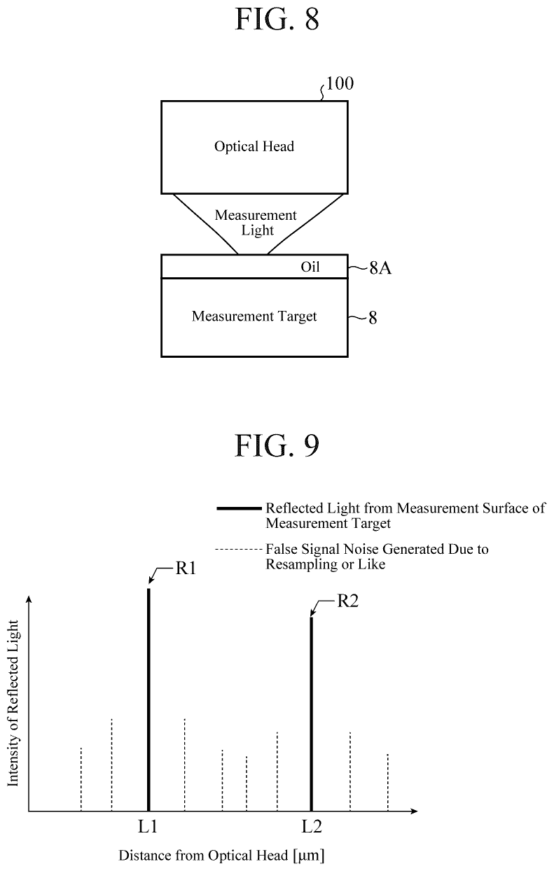

Also, as illustrated in FIG. 8, in a case where oil adheres to the measurement surface of the measurement target 8, the intensity of the reflected light from the surface of the oil film 8A is higher than the intensity of the reflected light from the measurement surface of the measurement target 8.

In this case, the intensities of the reflected light are similar to the intensities of the reflected light conceptually illustrated in FIG. 7. In FIG. 7 in this case, the solid line R1 indicates the intensity of the light reflected from the surface of the oil film 8A, the solid line R2 indicates the intensity of the light reflected from the measurement surface, and the dashed lines indicate the intensities of reflected light caused by harmonics due to resampling and false signal noises such as side lobes.

As can be seen from FIG. 7, in a case where a threshold for deleting the intensity of reflected light due to a false signal noise is simply set, when there is a step on the measurement surface, the intensity (R2) by the light reflected from the under surface of the irradiation surface is also deleted, and there is a possibility that the under surface of the measurement surface cannot be recognized. In a case where oil adheres to the measurement surface, when the reflected light having the highest intensity of the reflected light is selected, the distance L1 corresponding to the intensity (R1) by the reflected light indicating the distance to the surface of the oil film 8A is erroneously recognized as the distance to the measurement surface, and there is a possibility that an error due to the oil film 8A will occur in the measurement of the distance to the measurement surface of the measurement target 8.

The information processing unit 6 obtains spectrum information by performing Fourier transform on the measurement information from the measurement information acquiring unit 5, corrects the obtained spectrum information using variable factor information for the measurement of the distance to the measurement surface of the measurement target 8, and obtains information about the distance to the measurement surface of the measurement target 8 on the basis of the corrected spectrum information.

When the variable factor information related to the measurement of the distance to the measurement surface of the measurement target 8 is a characteristics parameter indicating optical characteristics of the irradiation optical system 3, the information processing unit 6 obtains spectrum information from which the amount of variation of the distance depending on the irradiation optical system 3 has been eliminated, using information regarding the characteristics parameter from the spectrum information, and obtains information about the distance to the measurement surface of the measurement target on the basis of the spectrum information indicating a peak value for the value of the obtained spectrum information.

When the variable factor for the measurement of the distance to the measurement surface of the measurement target 8 is a peripheral structure around the measurement target 8, the information processing unit 6 obtains spectrum information from which the amount of variation of the distance depending on the peripheral structure of the measurement target 8 has been eliminated, using information about the peripheral structure around the measurement target 8 from the spectrum information, and obtains information about the distance to the measurement surface of the measurement target, on the basis of spectrum information indicating a peak value for the value of the obtained spectrum information.

When variable factors related to the measurement of the distance to the measurement surface of the measurement target 8 are a characteristics parameter indicating optical characteristics of the irradiation optical system 3 and a peripheral structure around the measurement targets 8, the information processing unit 6 first obtains spectrum information using information regarding the characteristics parameter, then obtains spectrum information using information regarding the peripheral structure around the measurement target 8 from the obtained spectrum information, and obtains information about the distance to the measurement surface of the measurement target.

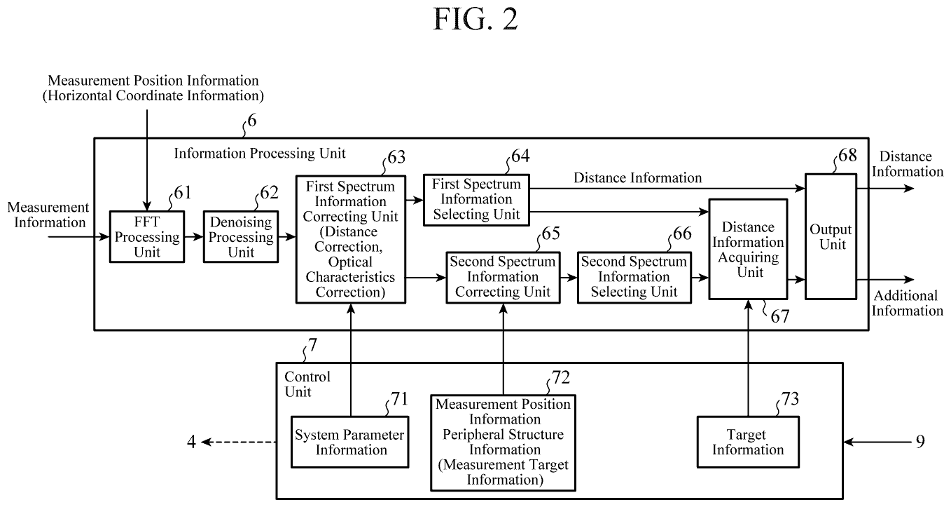

As illustrated in FIG. 2, the information processing unit 6 includes an FFT processing unit 61, a denoising processing unit 62, a first spectrum information correcting unit 63, a first spectrum information selecting unit 64, a second spectrum information correcting unit 65, a second spectrum information selecting unit 66, a distance information acquiring unit 67, and an output unit 68.

The FFT processing unit 61 performs fast Fourier transform on the measurement information from the measurement information acquiring unit 5 in synchronization with the horizontal coordinate information, which is measurement position information provided from the control unit 7 to the drive unit 4, and obtains spectrum information at the irradiation point of the measurement target 8 indicated by the horizontal coordinate information.

The FFT processing unit 61 functions as a spectrum acquiring unit based on the interfering light due to the reflected light for measurement and the reference light divided from the swept light subjected to wavelength sweep within the sweep range.

Note that the spectrum information obtained by the FFT processing unit 61 is information in which information indicating the intensity of the spectrum at the peak of the spectrum is associated with the horizontal coordinate information supplied to the drive unit 4 by the control unit 7.

The spectrum information obtained by the FFT processing unit 61 indicates the difference between the optical path of the reflected light for measurement and the optical path of the reference light through the difference between the frequency of the reflected light for measurement and the frequency of the reference light at the peak of the spectrum, and corresponds to provisional distance information with respect to the irradiation point of the measurement target 8, which provisionally indicates the distance to the measurement surface of the measurement target 8 at the irradiation point of the measurement target 8, the irradiation point being indicated by the horizontal coordinate information.

The denoising processing unit 62 compares the value of the spectrum information obtained by the FFT processing unit 61 with the threshold for denoising, eliminates the value of the spectrum information lower than the threshold for denoising, and obtains the spectrum information from which noises have been eliminated.

The threshold for denoising is a threshold acquired in advance, and is a peak value of the spectrum obtained by the FFT processing unit 61 putting the measurement light from the irradiation optical system 3 into a light blocking state.

Note that the threshold for denoising may be 1σ, instead of the peak value of the spectrum indicating noise, or may be a theoretical noise value obtained by network calculation.

If any denoising process is not performed by the denoising processing unit 62, when the dependency on the distance due to a variable factor for the measurement of the distance to the measurement surface of the measurement target 8 is eliminated in a later process, the longer the distance to the measurement surface of the measurement target 8, the more overcorrection occurs. As a result, the intensity of the spectrum due to noise becomes stronger in a pseudo manner, and discrimination from the intensity of the spectrum based on reflected light becomes difficult.

Accordingly, the denoising process by the denoising processing unit 62 eliminates influence of noise in the subsequent processes. Thus, the spectrum based on reflected light can be obtained with high accuracy even if the distance to the measurement surface of the measurement target 8 is long.

Further, as the threshold for denoising is made constant, the arithmetic processing load on the information processing unit 6 is reduced.

The first spectrum information correcting unit 63 obtains spectrum information obtained by eliminating the amount of variation of the distance depending on the irradiation optical system 3 from the spectrum information obtained by the denoising processing unit 62, using information regarding a characteristics parameter indicating optical characteristics of the irradiation optical system 3.

The first spectrum information correcting unit 63 performs correction on the spectrum information obtained by the denoising processing unit 62, to eliminate the distance dependency and the optical characteristics, using system parameter information that is the information regarding the characteristics parameter from the control unit 7.

The reception power Pr[w] of the reflected light that is received by the optical system 32 in the irradiation optical system 3 from the measurement surface of the measurement target 8 is expressed by Expression (2) shown below.

$$Pr ( L ) ∝ {P}_{T} {η}_{sys} {η}_{F} \frac{\frac{π {D}^{2}}{4} exp ( - 2 \int α ( L ) dL ) R ( L ) V ( L )}{{L}^{2} ( 1 + ( \frac{π {D}^{2}}{4 λ L} ) {( 1 - \frac{L}{F} )}^{2} )} \qquad ( 2 )$$

Note that, in Expression (2), PT represents the transmission power [w] of the measurement light emitted from the optical system 32 in the irradiation optical system 3, ηsys represents the efficiency of the system, ηF represents the coupling efficiency in the far field, L represents the distance [m] to the measurement surface of the measurement target 8, F represents the light-condensing distance [m] by the optical system 32, D represents the aperture diameter [m] of the lens of the optical system 32, α(L) represents the dissipation factor (1-transmittance) [/μm] with respect to the distance L, R(L) represents the reflectance with respect to the distance L, V(L) represents the area ratio with respect to the distance L, and λ represents the center frequency of wavelength in the sweep range in the swept light.

The reflectance R is 1, except for that for the distance L to the measurement surface of the measurement target 8. The area ratio Vis 1 when the measurement surface of the measurement target 8 is a flat surface. In a case where there is a step having a height difference between the upper surface and the under surface of the measurement surface of the measurement target 8 as illustrated FIG. 6, the area ratio V on the upper surface is set to 0.7, and the area ratio V on the under surface is set to 0.3, for example.

The first spectrum information correcting unit 63 corrects a term depending on the distance of the denominator indicated by the right side of the above Expression (2).

Specifically, the first spectrum information correcting unit 63 corrects the spectrum information obtained by the denoising processing unit 62, with respect to the variable factor information based on the characteristics parameter indicating the optical characteristics of the irradiation optical system 3, which is the variable factor information with respect to the measurement of the distance to the measurement surface of the measurement target 8.

Accordingly, the first spectrum information correcting unit 63 obtains spectrum information obtained by eliminating the amount of variation of the distance depending on the irradiation optical system 3 from the spectrum information obtained by the denoising processing unit 62, using a correction coefficient K (gain function) for the distance L expressed by Expression (3) shown below.

$$K ( L ) = {L}^{2} ( 1 + ( π {D}^{2} / 4 λ L ) {( 1 - L / F )}^{2} ) \qquad ( 3 )$$

That is, the first spectrum information correcting unit 63 obtains spectrum information corrected by multiplying the value of the spectrum for each distance L indicated by the spectrum information obtained by the denoising processing unit 62 by the correction coefficient K for each distance L expressed by Expression (3). Hereinafter, the corrected spectrum information will be described as the spectrum information after the first correction.

The spectrum information after the first correction corresponds to the spectrum information obtained by the FFT processing unit 61 performing Fourier transform on the measurement information that has been supplied from the measurement information acquiring unit 5 and is based on the interfering light obtained by the interference unit 51 in the measurement information acquiring unit 5 using the reflected light for measurement having the intensity of the reflected light for the distance from the irradiation surface of the optical head 100 conceptually illustrated in FIG. 9, in which the intensity of the reflected light for the distance from the irradiation surface of the optical head 100 conceptually illustrated in FIG. 7 is corrected, for example.

The first spectrum information selecting unit 64 obtains spectrum information indicating the highest peak value for the value of the spectrum information after the first correction obtained by the first spectrum information correcting unit 63. The spectrum information indicating the highest peak value in the spectrum information after the first correction, which is spectrum information indicated by the intensity of the spectrum corresponding to the intensity R1 by the reflected light illustrated in FIG. 9, is obtained as provisional distance information (information indicating the distance L1) to the measurement surface of the measurement target 8 at the position in the horizontal direction indicated by the horizontal coordinate information from the control unit 7.

The second spectrum information correcting unit 65 obtains spectrum information in which the amount of variation of the distance depending on a peripheral structure around the measurement target 8 has been eliminated from the spectrum information selected by the first spectrum information selecting unit 64, which is the spectrum information after the first correction, using the information regarding the peripheral structure around the measurement target 8.

The second spectrum information correcting unit 65 obtains presence information about an adhering substance and presence information about a step on the measurement surface of the measurement target 8 with respect to the spectrum information after the first correction, the presence information being the measurement position information and peripheral structure information (measurement target information) supplied from the control unit 7. In a case where an adhering substance is present on the measurement surface, the second spectrum information correcting unit 65 performs correction to eliminate the influence of the adhering substance, using the transmittance (dissipation factor) on the measurement surface. In a case where a step is present on the measurement surface of the measurement target 8, the second spectrum information correcting unit 65 performs correction on the position information about the step, using the reflectance from the measurement surface and the reception power of the reflected light, or, in other words, obtains highly accurate position information.

When there is no unique information about the measurement surface of the measurement target 8 such as the presence information about an adhering substance and the presence information about a step on the measurement surface, and the measurement surface of the measurement target is not in a unique state but in a flat or smooth state at the measurement position indicated by the measurement position information from the control unit 7, the provisional distance information (information indicating the distance L1) selected by the first spectrum information selecting unit 64, which is the information (information indicating the distance L1) about the distance to the measurement surface of the measurement target 8, is obtained, and the obtained distance information (information indicating the distance L1) is output via the output unit 68.

Note that the second spectrum information correcting unit 65 may obtain the spectrum information in which the amount of variation of the distance depending on the peripheral structure around the measurement target 8 has been eliminated from the spectrum information obtained by the denoising processing unit 62 using the information about the peripheral structure around the measurement target 8, without any intervention of the first spectrum information correcting unit 63 and the first spectrum information selecting unit 64.

It is now assumed that the information processing unit 6 has received, from the control unit 7, presence information about an adhering substance on the measurement surface of the measurement target 8.

The second spectrum information correcting unit 65 obtains the measurement position information and the adhering substance presence information from the control unit 7, and performs correction on the spectrum information after the first correction, to eliminate the influence of the adhering substance.

For example, as illustrated in FIG. 8, it is assumed that oil adheres to the measurement surface of the measurement target 8, and the optical head 100 measures the distance to the measurement surface of the measurement target 8 having the oil film 8A on the measurement surface.

In this case, in FIG. 9 illustrating the conceptual intensity of virtual reflected light for measurement corresponding to the spectrum information after the first correction obtained by the first spectrum information correcting unit 63, the distance L1 corresponding to the intensity R1 indicates the distance to the oil film 8A, and a distance L2 corresponding to the intensity R2 indicates the apparent distance L2 (>L1) to the measurement surface.

Thus, the second spectrum information correcting unit 65 obtains spectrum information from which the amount of variation of the distance depending on the oil film 8A as the adhering substance has been eliminated using the correction coefficient T (gain function) for the distance L expressed by Expression (4) shown below.

$$T = 1 / exp ( - 2 \int α ( L ) dL ) \qquad ( 4 )$$

Specifically, the second spectrum information correcting unit 65 obtains spectrum information corrected by multiplying the value of the spectrum for each distance L indicated by the spectrum information after the first correction by the correction coefficient T for each distance L indicated by Expression (4), or by multiplying the value indicated by the spectrum information after the first correction at the distance L1 or farther by the reciprocal of the transmittance of the oil, on the assumption that the oil film 8A is present at the distance L1 corresponding to the intensity R1 or farther.

The second spectrum information correcting unit 65 corrects the spectrum information after the first correction using the transmittance of the oil, to obtain spectrum information taking into account the attenuation of the intensity of the light of the reflected light from the measurement surface due to the transmittance of the oil to the measurement surface. Hereinafter, the corrected spectrum information will be described as the spectrum information after the second correction.

The reciprocal of the transmittance of the oil is information about the peripheral structure around the measurement target 8.

The second spectrum information selecting unit 66 obtains spectrum information indicating the second highest peak value for the value of the spectrum information after the second correction obtained by the second spectrum information correcting unit 65.

The second spectrum information selecting unit 66 obtains the spectrum information indicating the second highest peak value as provisional information (information indicating the distance L2) about the distance to the measurement surface of the measurement target 8 at the position in the horizontal direction indicated by the horizontal coordinate information from the control unit 7.

Since the spectrum information taking into account the attenuation of the intensity of the light of the reflected light from the measurement surface due to the transmittance of the oil has been obtained by the second spectrum information correcting unit 65, it is easy to select the spectrum information indicating the second highest peak value.

The distance information acquiring unit 67 examines data, in accordance with the environment and purpose of the measurement target 8 with respect to the provisional information (information indicating the distance L2) about the distance to the measurement surface of the measurement target 8 as selected by the second spectrum information selecting unit 66.

That is, the distance information acquiring unit 67 obtains substantial information (information indicating the distance L0) about the distance to the measurement surface of the measurement target 8 with respect to the provisional distance information (information indicating the distance L2).

The distance information acquiring unit 67 obtains the spectrum information selected by the second spectrum information selecting unit 66, which is spectrum information indicating the value obtained by subtracting the value of the thickness of the oil film 8A from the value of the provisional distance information (information indicating the distance L2), and outputs, via the output unit 68, the obtained distance information (information indicating the distance L0) as the substantial information about the distance to the measurement surface of the measurement target 8.

In other words, the distance information acquiring unit 67 obtains spectrum information indicating the value obtained by adding the value of the thickness of the oil film 8A to the value of the spectrum information (information indicating the distance L1) selected by the first spectrum information selecting unit 64 using Expression (5) shown below, and outputs, via the output unit 68, the spectrum information as the substantial information about the distance to the measurement surface of the measurement target 8.

$$L 0 = ( L 2 - L 1 ) / {n}_{0} + L 1 \qquad ( 5 )$$

Note that, in Expression (5), no represents the refractive index of the oil, and is supplied from the control unit 7 to the information processing unit 6.

The refractive index no of the oil is information regarding the peripheral structure around the measurement target 8.

As can be seen from Expression (5), the value of the thickness of the oil film 8A is a value ((L2−L1)/n₀) obtained by dividing a subtracted value (L2−L1) by the refractive index n₀ of the oil, the subtracted value (L2−L1) having been obtained by subtracting the distance L1, which is the value of the distance information based on the spectrum information indicating the first peak value selected by the first spectrum information selecting unit 64, from the distance L2, which is the value of the distance information based on the spectrum information indicating the second peak value selected by the second spectrum information selecting unit 66.

That is, the distance information acquiring unit 67 corrects a distance error depending on the difference in the refractive index no due to the oil as an adhering substance.

The optical measuring device according to the first embodiment configured as described above can accurately measure the distance to the measurement surface of the measurement target 8, even when the oil film 8A as an adhering substance is present on the measurement surface of the measurement target 8 as a variable factor for a measured distance.

The optical measuring device according to the first embodiment can increase the detection rate of the spectrum with the reflected light from the measurement surface of the measurement target 8 to which an oil film adheres, reduce the arithmetic processing load, and accurately correct the distance error.

Next, the second spectrum information correcting unit 65, the second spectrum information selecting unit 66, and the distance information acquiring unit 67 in a case where it is assumed that the information processing unit 6 has received, from the control unit 7, presence information indicating that there is a step on the measurement surface of the measurement target 8 are described.

The second spectrum information correcting unit 65 obtains the measurement position information and the presence information about the step from the control unit 7, and performs a process to correct the position of the step, which is the position of the boundary (edge) of the step having a height difference on the measurement surface with respect to the position of the edge indicated by the presence information about the step supplied from the control unit 7, in the spectrum information after the first correction obtained by the first spectrum information correcting unit 63. In other words, the second spectrum information correcting unit 65 performs a process for estimating the position of the edge with high accuracy.

For example, as illustrated in FIG. 6, it is assumed that there is a step having a height difference between the upper surface and the under surface in the measurement surface of the measurement target 8, and the optical head 100 measures the distance to each of the upper surface and the under surface, and the position of the edge on the measurement surface of the measurement target 8 having the step present on the measurement surface.

In this case, in FIG. 9 illustrating conceptual intensities of virtual reflected light for measurement corresponding to the spectrum information after the first correction obtained by the first spectrum information correcting unit 63, the distance L1 corresponding to the intensity R1 indicates the distance to the upper surface of the measurement surface, and the distance L2 corresponding to the intensity R2 indicates the distance L2 (>L1) to the under surface of the measurement surface.

As for the intensity R1 of the reflected light from the upper surface of the measurement surface and the intensity R2 of the reflected light from the under surface of the measurement surface, the intensity R2 is higher than the intensity R1, as illustrated in FIG. 9, because of the dependency of reception intensity on distance and the dependency of the reflectance and the like at the measurement surface on the measurement target 8.

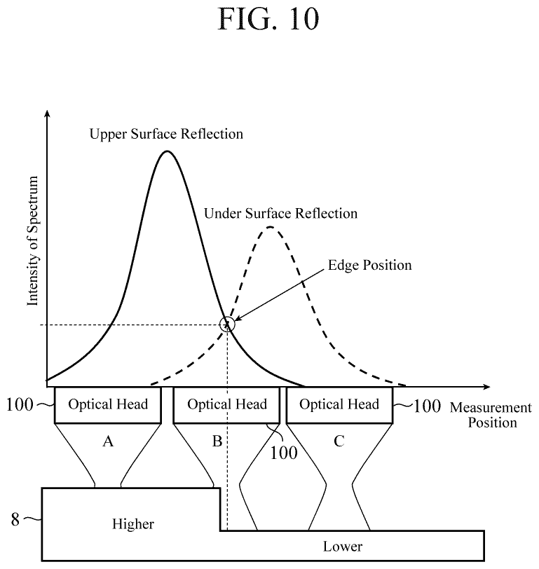

In a case where the focal point of the irradiation optical system 3 is set on the upper surface of the measurement surface, and the optical head 100 has moved from a position A to a position B and from the position B to a position C as illustrated in FIG. 10, spots of the measurement light from the irradiation optical system 3 are all located on the upper surface of the measurement surface of the measurement target 8 at the position A immediately before the optical head 100 reaches the position of the edge. Accordingly, the intensity of the peak of the spectrum based on the reflected light from the upper surface of the measurement surface of the measurement target 8 reaches the maximum value. At this point of time, there is no reflected light from the under surface of the measurement surface of the measurement target 8.

Note that, in FIG. 10, the transverse direction in the drawing is the X-axis direction, the depth direction is the Y-axis direction, the vertical direction is the Z-axis direction, the horizontal direction is the X-axis direction and the Y-axis direction, and the horizontal plane is the X-Y plane. Movement from A to B to C is movement in the X-axis direction.

When the optical head 100 further moves to reach the position of the edge, part of the spot of the measurement light from the irradiation optical system 3 reaches the under surface of the measurement surface of the measurement target 8, and the intensity of the peak of the spectrum based on the reflected light from the upper surface of the measurement surface of the measurement target 8 gradually decreases, because the intensity of the peak of the spectrum is proportional to the area of the spot of the measurement light.

On the other hand, the intensity of the peak of the spectrum based on the reflected light from the under surface of the measurement surface of the measurement target 8 gradually increases, as part of the spot of the measurement light from the irradiation optical system 3 starts reaching the under surface of the measurement surface of the measurement target 8.

When the optical head 100 moves from the position B to the position C, the spot of the measurement light from the irradiation optical system 3 moves to the under surface of the measurement surface of the measurement target 8, the intensity of the peak of the spectrum based on the reflected light from the upper surface of the measurement surface of the measurement target 8 further decreases, the area of the spot on the upper surface becomes zero at the position C, and there is no reflected light from the upper surface of the measurement surface of the measurement target 8.

On the other hand, as for the intensity of the peak of the spectrum based on the reflected light from the under surface of the measurement surface of the measurement target 8, the intensity of the peak of the spectrum based on the reflected light from the under surface of the measurement surface of the measurement target 8 increases as the spot of the measurement light from the irradiation optical system 3 moves to the under surface of the measurement surface of the measurement target 8, and the intensity of the peak of the spectrum based on the reflected light reaches the maximum value at the position C at the spot of the measurement light from the irradiation optical system 3.

In short, in a case where the optical head moves from the position A to the position B, and from the position B to the position C, the intensity of the peak of the spectrum based on the reflected light from the upper surface of the measurement surface of the measurement target 8 reaches the maximum value at the position A, and the intensity of the peak of the spectrum based on the reflected light from the under surface of the measurement surface of the measurement target 8 reaches the maximum value at the position C.

The maximum value of the peak of the spectrum based on the reflected light from the under surface is smaller than the maximum value of the peak of the spectrum based on the reflected light from the upper surface.

Therefore, when the spectrum information after the first correction obtained by the first spectrum information correcting unit 63 is used in simply defining the position of the edge at the time when the intensity of the peak of the spectrum based on the reflected light from the upper surface of the measurement surface of the measurement target 8 and the intensity of the peak of the spectrum based on the reflected light from the under surface of the measurement surface of the measurement target 8 have the same value, the intensity of the peak of the spectrum based on the reflected light from the upper surface of the measurement surface of the measurement target 8 is higher than the intensity of the peak of the spectrum based on the reflected light from the under surface of the measurement surface of the measurement target 8 at the actual edge. Accordingly, the position of the defined edge indicates a position to the right of the actual edge, as illustrated in FIG. 10.

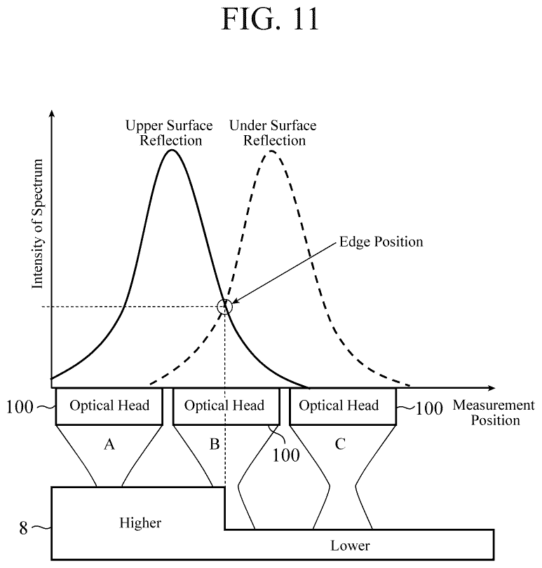

As illustrated in FIG. 11, the second spectrum information correcting unit 65 performs correction so that the intensity of the peak of the spectrum based on the reflected light from the upper surface of the measurement surface of the measurement target 8 and the intensity of the peak of the spectrum based on the reflected light from the under surface of the measurement surface of the measurement target 8 have the same value, and performs preprocessing for defining the position of the edge when the values are regarded as the same.

The second spectrum information correcting unit 65 obtains the measurement position information and the presence information about the step from the control unit 7, and obtains spectrum information in which the influence of the step has been eliminated from the spectrum information after the first correction.

The second spectrum information correcting unit 65 obtains the spectrum information corrected by multiplying the value of the spectrum information after the first correction by a correction coefficient G (gain function) in which the ratio of the under surface to the upper surface forming the step on the measurement surface of the measurement target 8 is a value greater than 1, or by correcting the second peak value at which the intensity of the peak of the spectrum based on the reflected light from the under surface reaches the maximum value, to a value equal to the first peak value at which the intensity of the peak of the spectrum based on the reflected light from the upper surface reaches the maximum value. Hereinafter, the corrected spectrum information will be described as the spectrum information after the second correction.

The correction coefficient G is the information regarding the peripheral structure around the measurement target 8.

In the first embodiment, the correction coefficient G is a step function that indicates 1 for the upper surface, and a value larger than 1 for the under surface.

The correction coefficient G is the product of a first correction coefficient Gr based on the reciprocal of the reflectance and a second correction coefficient Gd based on the power ratio (PR_{H}/PR_{L}) between the reception power PR_{H} of the reflected light from the upper surface and the reception power PR_{L} of the reflected light from the under surface.

The second spectrum information correcting unit 65 first sets the distance information L1 indicated by the spectrum information indicating the highest peak value in the spectrum information after the first correction selected by the first spectrum information selecting unit 64 as the distance L1 to the upper surface of the measurement surface of the measurement target 8, and obtains an under-side step L in the downward direction from the upper surface according to Expression (6) shown below, on the basis of a step height ΔL and a margin β in the presence information about the step supplied from the control unit 7.

$$L \geq L 1 + Δ L - β \qquad ( 6 )$$

In Expression (6), the margin β is ¼ of the step height ΔL, or 6 σ of the distance accuracy of the irradiation optical system 3, for example.

The second spectrum information correcting unit 65 assigns the reflectance of the under-side step L, which is the reflectance R1 by the under surface of the measurement surface of the measurement target 8, to R in Expression (7) shown below, to obtain the first correction coefficient Gr (LD) for the under-side step, and assigns the reflectance of the upper-side step that is not the under-side step L, which is the reflectance R0 by the upper surface of the measurement surface of the measurement target 8, to R in Expression (7), to obtain the first correction coefficient Gr (LU) for the upper-side step.

$$Gr ( L ) = 1 / R ( L ) \qquad ( 7 )$$

Since the reflectance R1 by the under surface is lower than the reflectance R0 by the upper surface, the first correction coefficient Gr (LD) for the under-side step is greater than the first correction coefficient Gr (LU) for the upper-side step.

On the assumption that the first correction coefficient Gr (LU) for the upper-side step is 1, the first correction coefficient Gr (LD) for the under-side step is a value that is greater than 1 and is proportional to the value obtained according to Expression (7).

The second spectrum information correcting unit 65 obtains spectrum information corrected by multiplying the spectrum information after the first correction by the first correction coefficient Gr. Hereinafter, the corrected spectrum information will be described as the spectrum information after the second pre-stage correction.

The second spectrum information correcting unit 65 obtains the reception power PR_{H} of the reflected light from the upper surface of the measurement surface of the measurement target 8 according to Expression (8) shown below, and obtains the reception power PR_{L} of the reflected light from the under surface according to Expression (9) shown below. Note that Expression (8) indicates an example in which a step is present in the X-axis direction.

$${PR}_{H} = {\int }_{- {ω}_{0}}^{{ω}_{0}} {\int }_{- {ω}_{0}}^{X 1} \frac{1}{\sqrt{2 π σ}} {exp}^{- 1 / 2} ( \frac{{x}^{2} + {y}^{2}}{{σ}^{2}} ) dxdy \qquad ( 8 )$$

$$PL = 1 - {P}_{H} \qquad ( 9 )$$

In Expression (8), X1 represents the difference in the X-axis direction between the position of the measurement light from the irradiation optical system 3 on the X-axis of the optical axis and the position of the edge on the X-axis indicated by the presence information about the step supplied from the control unit 7, ω0 is expressed by Expression (10) shown below, and ω(L) for each distance is expressed by Expression (11) shown below.

$$ω 0 = λ / πθ \qquad ( 10 )$$

$$ω ( L ) = {ω}_{0} \sqrt{1 + {( \frac{λ z}{π {ω}_{0}} )}^{2}} \qquad ( 11 )$$

In Expression (10), 0 represents the divergence angle of the measurement light from the irradiation optical system 3, and λ represents the wavelength of the measurement light from the irradiation optical system 3.

The second spectrum information correcting unit 65 assigns the reception power PR_{L} of the reflected light from the under surface to PR in Expression (12) shown below at the under-side step L, to obtain the second correction coefficient Gd (LD) for the under-side step, and assigns the reception power PR_{H} of the reflected light from the upper surface to PR in Expression (12) at the upper-side step other than the under-side step L, to obtain the second correction coefficient Gd (LU) for the upper-side step.

$$Gd ( L ) = 1 / PR ( L ) \qquad ( 12 )$$

Since the reception power PR_{L} of the reflected light from the under surface is smaller than the reception power PR_{H} of the reflected light from the upper surface, the second correction coefficient Gd (LD) for the under-side step L is larger than the second correction coefficient Gd (LU) for the upper-side step.

On the assumption that the second correction coefficient Gd (LU) for the upper-side step is 1, the second correction coefficient Gd (LD) for the under-side step is a value that is greater than 1 and is proportional to the value obtained according to Expression (12).

The second spectrum information correcting unit 65 obtains spectrum information corrected by multiplying the spectrum information after the second pre-stage correction by the second correction coefficient Gd. Hereinafter, the corrected spectrum information will be described as the spectrum information after the second correction.

As a result, the second spectrum information correcting unit 65 obtains the spectrum information after the second correction obtained by multiplying the spectrum information after the first correction by the value obtained by multiplying the first correction coefficient Gr by the second correction coefficient Gd.

The step height ΔL on the measurement surface of the measurement target 8 and the reflectance R on the measurement surface of the measurement target 8 are the information regarding the peripheral structure around the measurement target 8.

In a case where both the first correction coefficient Gr (LU) and the second correction coefficient Gd (LU) at the upper-side step are set to 1, the value of the correction coefficient G (LU) obtained by multiplying the first correction coefficient Gr (LU) by the second correction coefficient Gd (LU) at the upper-side step is 1, and the value of the correction coefficient G (LD) obtained by multiplying the first correction coefficient Gr (LD) by the second correction coefficient Gd (LD) at the under-side step L is a value greater than 1.

Since the second spectrum information correcting unit 65 has obtained the spectrum information after the second correction by multiplying the spectrum information after the first correction by the value of the product of correction coefficients G formed with the correction coefficient G (LU) at the upper-side step by the correction coefficient G (LD) at the under-side step L, the second peak value at which the intensity of the peak of the spectrum of the spectrum information at the under-side step L reaches the maximum value can be increased in the spectrum information after the second correction, and be made substantially the same as the first peak value at which the intensity of the peak of the spectrum of the spectrum information at the upper-side step reaches the maximum value.

The second spectrum information selecting unit 66 obtains spectrum information indicating the highest peak value at the under-side step L, with respect to the value of the spectrum information after the second correction obtained by the second spectrum information correcting unit 65.

The spectrum information indicating the highest peak value at the under-side step L is defined as the spectrum information indicating the second peak value.

On the other hand, the second spectrum information selecting unit 66 obtains the spectrum information indicating the highest peak value at the upper-side step, with respect to the value of the spectrum information after the second correction.

The spectrum information indicating the highest peak value at the upper-side step indicates the first peak value, and the first peak value is substantially the same as the first peak value indicated by the spectrum information selected by the first spectrum information selecting unit 64.

Accordingly, the spectrum information indicating the first peak value selected by the second spectrum information selecting unit 66 is regarded as the spectrum information indicating the first peak value selected by the first spectrum information selecting unit 64.

That is, the spectrum information indicating the first peak value selected by the first spectrum information selecting unit 64 includes the spectrum information indicating the first peak value selected by the second spectrum information selecting unit 66 in terms of the technical scope.

Note that, with respect to the value of the spectrum information after the second correction, the spectrum information indicating the second highest peak value, which is lower than the first peak value at the upper-side step, is regarded as a harmonic component due to the reflected light at the upper-side step.

The distance information acquiring unit 67 obtains the absolute value P_{diff} of the difference between the first peak value P1 indicated by the spectrum information selected by the second spectrum information selecting unit 66 or the first peak value P1 indicated by the spectrum information selected by the first spectrum information selecting unit 64, and the second peak value P2 indicated by the spectrum information selected by the second spectrum information selecting unit 66, according to Expression (13) shown below.

$${P}_{diff} ( X ) = \vert P 1 - P 2 \vert \qquad ( 13 )$$

The distance information acquiring unit 67 sets the position in the horizontal direction at which the difference P_{diff} between the peak values in Expression (12) indicates a local minimum value, which is the position in the X-axis direction in this example, as the center of the step, which is the position of the edge.

The position in the X-axis direction is the position indicated by the X-coordinate in the horizontal coordinate information associated with the spectrum information indicating the first peak value P1 at which the difference P_{diff} indicates a local minimum value.

The distance information acquiring unit 67 outputs, via the output unit 68, the horizontal coordinate information associated with spectrum information indicating the first peak value P1 at which the difference P_{diff} indicates a local minimum value, as additional information indicating the position of the edge of the step present on the measurement surface of the measurement target 8.

In the optical measuring device according to the first embodiment configured as described above, the second spectrum information correcting unit 65 corrects the spectrum information after the first correction so that the second peak value P2 becomes equal to the first peak value P1, and thus, the position of an edge of a step present on the measurement surface of the measurement target 8, which is a variable factor for a measured distance, can be measured with high accuracy.

The optical measuring device according to the first embodiment can detect the position of the edge with a resolution higher than the spatial resolution determined by the beam diameter of the measurement light emitted from the optical system 32 in the irradiation optical system 3.

Also, the distance information acquiring unit 67 obtains the spectrum information indicating the first peak value P1 at which the difference P diff indicates a local minimum value as the information (information indicating the distance L1) about the distance to the upper surface of the measurement surface of the measurement target 8 at the position in the horizontal direction indicated by the associated horizontal coordinate information that is the horizontal coordinate information from the control unit 7, and outputs the distance information via the output unit 68.

The distance information acquiring unit 67 obtains the spectrum information indicating the second peak value P2 at which the difference P_{diff} indicates a local minimum value as the information (information indicating the distance L2) about the distance to the under surface of the measurement surface of the measurement target 8 at the position in the horizontal direction indicated by the horizontal coordinate information associated with the spectrum information indicating the first peak value P1, which is the horizontal coordinate information from the control unit 7, and outputs the distance information via the output unit 68.

In a case where there is no unique information on the measurement surface such as the presence information about an adhering substance and the presence information about a step on the measurement surface of the measurement target 8, the output unit 68 outputs the spectrum information selected by the first spectrum information selecting unit 64 as the information about the distance to the measurement surface of the measurement target 8.

In a case where there is the presence information indicating that an adhering substance is present on the measurement surface of the measurement target 8, the output unit 68 outputs the spectrum information obtained by the distance information acquiring unit 67 correcting the distance error in the spectrum information selected by the second spectrum information selecting unit 66, as the information about the distance to the measurement surface of the measurement target 8.

In a case where there is the presence information indicating the presence of a step on the measurement surface of the measurement target 8, the output unit 68 outputs, as additional information, the information indicating the position of the edge of the step estimated by the distance information acquiring unit 67, using the spectrum information indicating the first peak value and the spectrum information indicating the second peak value as selected by the second spectrum information selecting unit 66.

Further, in a case where there is the presence information indicating that a step is present on the measurement surface of the measurement target 8, the spectrum information indicating the first peak value selected by the second spectrum information selecting unit 66 with respect to the position of the edge of the step estimated by the distance information acquiring unit 67 is output as the information about the distance to the upper surface of the measurement surface of the measurement target 8, and the spectrum information indicating the second peak value is output as the information about the distance to the under surface of the measurement surface of the measurement target 8.

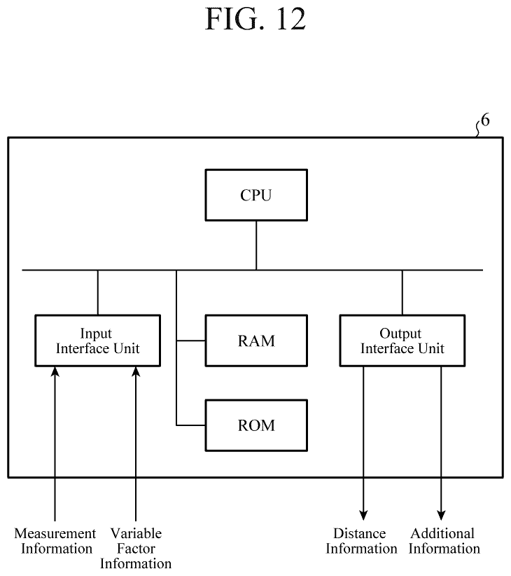

The information processing unit 6 is formed with a hardware configuration of a general personal computer (PC), and includes a central processing unit (CPU), a semiconductor memory (a random access memory (RAM)), a storage device (a read only memory (ROM)) such as a nonvolatile recording device, an input interface unit, an output interface unit, and a signal path (bus), as illustrated in FIG. 12.

The CPU controls and manages the RAM, the ROM, the input interface unit, and the output interface unit.

The CPU loads a program stored in the ROM into the RAM, and the CPU performs various processes in accordance with the program loaded into the RAM.

The CPU outputs the information about the distance to the measurement surface of the measurement target 8 and the additional information that is the position information about the edge of the step on the measurement surface, on the basis of the measurement information from the measurement information acquiring unit 5, and the variable factor information and the horizontal coordinate information from the control unit 7, in accordance with the program loaded into the RAM. The information processing unit 6 is driven by a general-purpose OS.

Note that the information processing unit 6 is not necessarily a PC, but may be an application specific integrated circuit (ASIC), a programmable logic device (PLD), a field-programmable gate array (FPGA), a system-on-a-chip (SoC), a system large-scale integration (LSI), or the like.

The control unit 7 has a function of collecting information such as variable factors and giving information such as variable factors to the information processing unit 6, and a function of controlling the drive unit 4. The control unit 7 has a hardware configuration of a general PC, and an optical camera or a user interface, and includes hardware or an interface capable of recognizing a state of the measurement target 8.

The PC forming the control unit 7 is also used as a PC forming the information processing unit 6.

The control unit 7 has: (1) a function of changing the position at which measurement is to be performed, by controlling the drive unit 4; (2) a function of giving sensor parameters to the information processing unit 6; (3) a function of giving the presence information about an adhering substance to the information processing unit 6; and (4) a function of giving the presence information about a step to the information processing unit 6.

(1) The function of changing the position is a function of outputting scan information that is measurement position information, to the drive unit 4 in which the optical head 100 is installed, to cause the optical head 100 to perform raster scan or spiral scan.

The measurement position information is input via a user interface forming the control unit 7 connected to a LAN or the like, and is stored into the RAM of the PC forming the control unit 7.

Alternatively, the measurement position information may be input via a serial interface such as a USB or RS232C, and be stored into the RAM of the PC forming the control unit 7.

Further, on the basis of an image of the measurement target 8 captured by the optical camera, when the measurement target 8 is rectangular, the CPU of the PC forming the control unit 7 may automatically read raster scan from the RAM, and give scan information for causing the drive unit 4 to perform raster scan. When the measurement target 8 is circular, the CPU may read spiral scan from the RAM, automatically give scan information for causing the drive unit 4 to perform spiral scan, and automatically select efficient scan by the optical head 100 on the measurement surface of the measurement target 8.

At the same time, the CPU of the PC forming the control unit 7 provides the information processing unit 6 with the horizontal position information in the scan information for causing the drive unit 4 to perform scan.

(2) The function of giving sensor parameters (system parameters) to the information processing unit 6 is a function of giving the threshold for denoising for the denoising processing unit 62 to perform denoising, and giving characteristics parameter information to the first spectrum information correcting unit 63.

The threshold for denoising and the characteristics parameter information are input beforehand via the user interface or the like forming the control unit 7, and are stored into the RAM of the PC forming the control unit 7.

The characteristics parameter information is information indicating the light-condensing distance F by the optical system 32, the aperture diameter D of the lens of the optical system 32, the center frequency λ of wavelength in the sweep range in the swept light, the dissipation factor (1-transmittance) α(L) with respect to the distance L, the reflectance R(L) with respect to the distance L, and the area ratio V(L) with respect to the distance L.

The sensor parameters are parameters for correcting the distance dependency of the reception intensity of reflected light in the irradiation optical system 3.

Note that the transmittance a is obtained by actual measurement, and the obtained actual measurement value is input beforehand via the user interface or the like forming the control unit 7 and is stored into the RAM of the PC forming the control unit 7.

A method for obtaining the transmittance a by actual measurement may be derived by performing fitting with the actual measurement value using the above Expression (2), with the transmittance a being a variable.

Information about the transmittance a may be associated with images obtained by the optical camera and be stored as a table into the RAM, or the basic information holding amount may be increased at any time using machine learning.

(3) The function of giving the presence information about an adhering substance on the measurement surface of the measurement target 8 to the information processing unit 6 is a function of giving the presence information about the adhering substance to the second spectrum information correcting unit 65 and the distance information acquiring unit 67.

The presence information about the adhering substance is input beforehand via the user interface or the like forming the control unit 7, and is stored into the RAM of the PC forming the control unit 7.

The presence information about the adhering substance to be given to the second spectrum information correcting unit 65 is information indicating the presence or absence of an oil film and the transmittance a (L) of the oil film, in a case where the adhering substance is the oil film 8A.

The presence information about the adhering substance to be given to the distance information acquiring unit 67 is information indicating the refractive index no of the oil film in the case where the adhering substance is the oil film 8A.

The presence information about the adhering substance is stored in a table format into the RAM, and information indicating the transmittance a (L) of the oil film and the refractive index no of the oil film may be selected from the adhering substance presence information stored in the table format.

Also, information indicating the transmittance a (L) of the oil film and the refractive index no of the oil film may be selected on the basis of the presence or absence of an oil film, which has been estimated from an image of the measurement target 8 captured by the optical camera, and the adhering substance presence information stored in the table form in the RAM.

In this case, an image associated beforehand with the adhering substance presence information stored in the table format in the RAM via the user interface or the like may be registered, and thus, the adhering substance presence information associated with the pre-registered image having the closest correlation with the image of the measurement target 8 captured by the optical camera may be selected. Machine learning may be used in selecting the pre-registered image having the closest correlation with the captured image.

Also, the refractive index no of the oil film may be obtained by actual measurement, and the obtained actual measurement value may be input beforehand via the user interface or the like forming the control unit 7 and be stored into the RAM of the PC forming the control unit 7.

The method for obtaining the refractive index no of the oil film by actual measurement may be obtained by preparing a measurement target having a known thickness and calculating the refractive index by calculating the ratio between the obtained distance value and the known thickness.

(4) The function of giving the presence information about a step to the information processing unit 6 is a function of giving the presence information about the step to the second spectrum information correcting unit 65 and the distance information acquiring unit 67.

The presence information about the step is input beforehand via the user interface or the like forming the control unit 7, and is stored into the RAM of the PC forming the control unit 7.

The presence information about the step is step information obtained from 3D CAD information about the measurement target 8, information about characteristics parameters of the optical system 32, and the reflectance of the measurement surface of the measurement target 8.

The step information obtained from 3D CAD information about the measurement target 8 may be step information obtained by analyzing an image of the measurement target 8 captured by the optical camera.

The step information in the presence information about the step is associated with the horizontal position information.

The presence information about the step is information indicating the step height ΔL.

The information about the characteristics parameters of the optical system 32 is information indicating the divergence angle θ of the measurement light from the optical system 32 and the wavelength λ of the measurement light from the optical system 32.

The reflectance of the measurement surface of the measurement target 8 may be obtained indirectly on the basis of the color and material of the measurement target 8. The color and material of the measurement target 8 are input beforehand via the user interface or the like forming the control unit 7, and a table indicating the relationship between the color and material of the measurement target 8 and the reflectance is stored into the RAM of the PC forming the control unit 7.

Note that, as for the reflectance of the measurement surface of the measurement target 8, a value actually measured in advance may be stored in the RAM.

Note that, in the optical measuring device according to the first embodiment, a polarization maintaining fiber that maintains two orthogonal polarization states is preferably used as the optical fiber to be used in the measurement light path from the light dividing unit 2 to the photoelectric conversion unit 52 of the measurement information acquiring unit 5. As the polarization maintaining fiber is used, the influence on retardation caused by a factor that is not present in the measurement targets 8 is made less likely to occur, and measurement can be performed under a condition where the retardation variation in the air layer from the irradiation optical system 3 to the measurement target 8 is small.

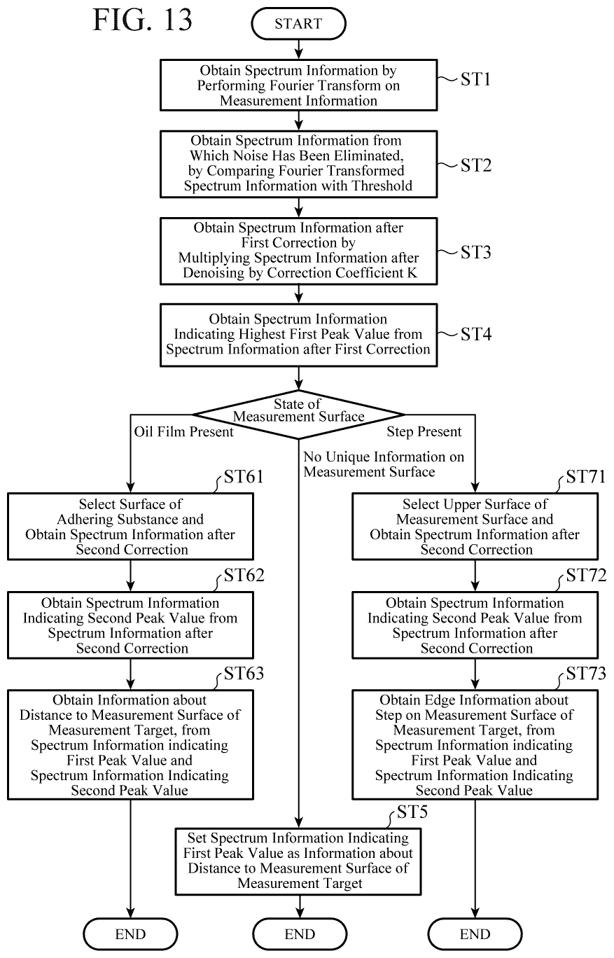

Next, operations in the optical measuring device according to the first embodiment, or mainly operations to be performed by the information processing unit 6 are described with reference to FIG. 13.

The output light for measurement obtained by the light dividing unit 2 dividing the swept light from the wavelength-swept light source 1 is emitted as the measurement light toward the measurement surface of the measurement target 8 by the irradiation optical system 3.

The measurement light emitted from the irradiation optical system 3 is reflected by the measurement surface of the measurement target 8, is input as the reflected light to the irradiation optical system 3, and is output as the reflected light for measurement from the irradiation optical system 3 to the measurement information acquiring unit 5.

Also, the output light for measurement obtained by the light dividing unit 2 dividing the swept light from the wavelength-swept light source 1 is input as the reference light to the measurement information acquiring unit 5.

The measurement information acquiring unit 5 multiplexes the input reflected light for measurement from the irradiation optical system 3 and the reference light from the light dividing unit 2 with the interference unit 51, photoelectrically converts the multiplexed interfering light with the photoelectric conversion unit 52, converts the photoelectrically converted analog electric signal into digital information with the digital conversion unit 53, and outputs the converted digital information as the measurement information.

The reflected light for measurement from the irradiation optical system 3 and the reference light from the light dividing unit 2, which are to be obtained as the measurement information, are based on swept light beams emitted from the wavelength-swept light source 1 at the same timing.

Further, the timing of emission of swept light from the wavelength-swept light source 1 and the horizontal coordinate information (measurement position information) to be given from the control unit 7 to the drive unit 4 are synchronized with each other, and the irradiation point on the measurement surface of the measurement target 8 indicated by the horizontal coordinate information and the measurement information correspond to each other.

That is, the measurement information acquiring unit 5 sequentially outputs the measurement information for the irradiation point moving on the measurement surface of the measurement target 8, in synchronization with the timing of emission of swept light from the wavelength-swept light source 1.

In step ST1 illustrated in FIG. 13, the FFT processing unit 61 in the information processing unit 6 that has received the measurement information from the measurement information acquiring unit 5 performs Fourier transform on the measurement information from the measurement information acquiring unit 5 in synchronization with the horizontal coordinate information from the control unit 7, to obtain spectrum information at the irradiation point on the measurement target 8 indicated by the horizontal coordinate information.

Step ST1 is a Fourier transform processing step.

The information processing unit 6 sequentially obtains spectrum information with respect to the irradiation point moving on the measurement surface of the measurement target 8 in synchronization with the timing of emission of swept light from the wavelength-swept light source 1, and obtains the spectrum information associated with the horizontal coordinate information.

Steps after step ST1 are processes that are performed by the information processing unit 6.

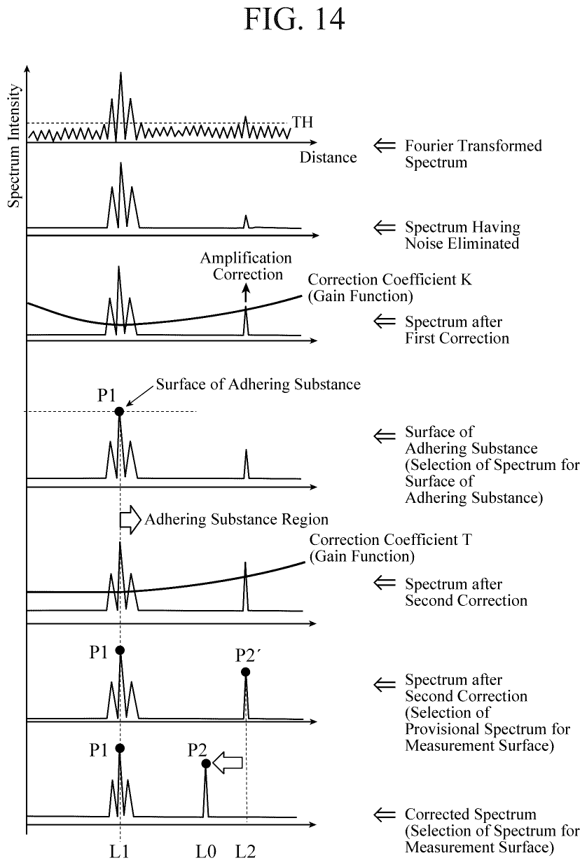

In a case where the measurement light emitted from the irradiation optical system 3 has the irradiation point on the surface of the measurement surface of the measurement target 8 to which oil adheres as illustrated in FIG. 8 (hereinafter referred to simply as the case where oil adheres to the measurement surface), the spectrum obtained by the FFT processing unit 61 performing Fourier transform on the measurement information from the measurement information acquiring unit 5 is illustrated as the “Fourier transformed spectrum” in FIG. 14.

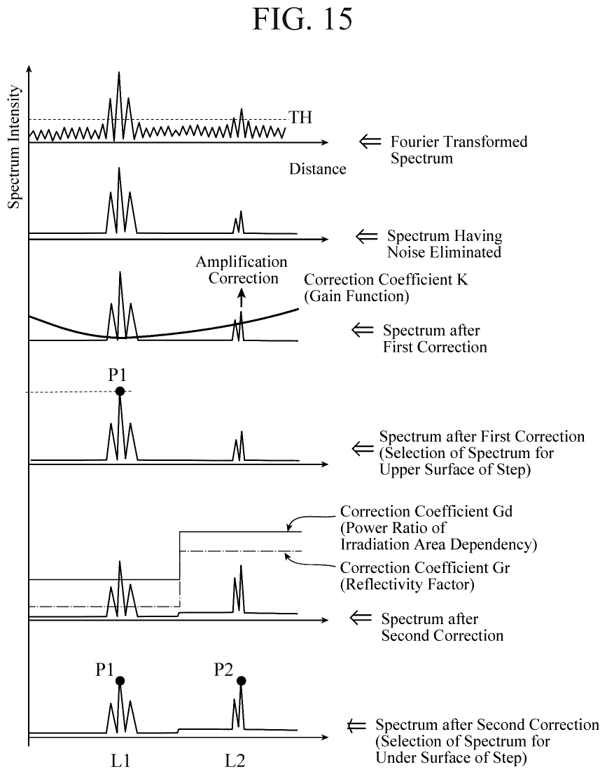

Further, in a case where there is a step on the measurement surface of the measurement target 8, and the measurement light emitted from the irradiation optical system 3 has the irradiation point at an edge of the step as illustrated in FIG. 6 (hereinafter referred to simply as the case where there is a step on the measurement surface), the spectrum obtained by the FFT processing unit 61 performing Fourier transform on the measurement information from the measurement information acquiring unit 5 is illustrated as the “Fourier transformed spectrum” in FIG. 15.

In step ST2, the denoising processing unit 62 in the information processing unit 6 compares the value of the spectrum information from the FFT processing unit 61 with the threshold for denoising, eliminates the value of the spectrum information lower than the threshold for denoising TH, and obtains the spectrum information from which noises have been eliminated.

Step ST2 is a threshold processing step.

In the case where oil adheres to the measurement surface, the spectrum from which noises have been eliminated by the denoising processing unit 62 is illustrated as the “spectrum from which noises have been eliminated” in FIG. 14.

As can be seen from FIG. 14, the spectra other than the spectrum generated by the light reflected from the surface of the oil film 8A and the spectrum generated by the light reflected from the measurement surface of the measurement target 8 are eliminated.

In the case where there is a step on the measurement surface, the spectrum from which noises have been eliminated by the denoising processing unit 62 is illustrated as the “spectrum from which noises have been eliminated” in FIG. 15.

As can be seen from FIG. 15, the spectra other than the spectrum by the light reflected from the upper surface of the step and the spectrum by the light reflected from the under surface of the step are eliminated.

In step ST3, the first spectrum information correcting unit 63 in the information processing unit 6 obtains spectrum information obtained by eliminating the amount of variation of the distance depending on the irradiation optical system 3 using the information regarding the characteristics parameters indicating the optical characteristics of the irradiation optical system 3, from the spectrum information obtained by the denoising processing unit 62.

That is, in step ST3, the first spectrum information correcting unit 63 obtains the spectrum information after the first correction corrected by multiplication with the correction coefficient K shown in the above Expression (3).

Step ST3 is a first correction processing step.

In the case where oil adheres to the measurement surface, the spectrum obtained by the first spectrum information correcting unit 63 performing multiplication with the correction coefficient K is illustrated as the “spectrum information after first correction” in FIG. 14.

As can be seen from FIG. 14, the value of the spectrum by the light reflected from the measurement surface of the measurement target 8 becomes greater.

In the case where there is a step on the measurement surface, the spectrum obtained by the first spectrum information correcting unit 63 performing multiplication with the correction coefficient K is illustrated as the “spectrum information after first correction” in FIG. 15.

As can be seen from FIG. 15, the value of the spectrum by the light reflected from the under surface of the measurement surface of the measurement target 8 becomes greater.

In step ST4, the first spectrum information selecting unit 64 in the information processing unit 6 obtains spectrum information indicating the highest peak value with respect to the value of the spectrum information after the first correction obtained by the first spectrum information correcting unit 63.

Step ST4 is a first selection processing step that is a step of selecting the spectrum indicating the first peak value.

In steps ST1 to ST4, the same processing is performed in a case where there is no unique information with respect to the measurement surface of the measurement target 8, and in a case where there is the presence information about an adhering substance and the presence information about a step.

If there is no unique information on the measurement surface of the measurement target 8, the process moves on to step ST5, and the spectrum information indicating the first peak value selected by the first spectrum information selecting unit 64 is output from the output unit 68 as the information about the distance to the measurement surface of the measurement target 8.

If there is no unique information with respect to the measurement surface of the measurement target 8, the spectrum information after the first correction obtained through steps ST1 to ST3 does not include the spectrum indicating the second peak value as illustrated in the “spectrum information after first correction” in FIGS. 14 and 15. Accordingly, in step ST4, the value of the spectrum information indicating the first peak value indicating the highest peak value in the “spectrum after first correction” indicates the distance to the measurement surface of the measurement target 8.

When the information processing unit 6 receives the presence information about an adhering substance on the measurement surface of the measurement target 8 from the control unit 7, the information processing unit 6 sets the spectrum information indicating the first peak value P1 indicating the highest peak value in the spectrum information after the first correction obtained in step ST4, as the spectrum information indicating the information (information indicating the distance L1) about the distance to the surface of the adhering substance adhering to the measurement surface of the measurement target 8, as illustrated in the “spectrum information after first correction” in FIG. 14 (step ST61).

In step ST61, the second spectrum information correcting unit 65 in the information processing unit 6 further obtains the spectrum information obtained by eliminating the amount of variation of the distance depending on the adhering substance on the measurement target 8 using the information about the adhering substance adhering to the measurement surface of the measurement target 8, from the spectrum information after the first correction obtained in step ST3.

That is, in step ST61, the second spectrum information correcting unit 65 obtains the spectrum information after the second correction performed by multiplying the value of the spectrum information after the first correction by the correction coefficient T shown in the above Expression (4).

The spectrum obtained by the second spectrum information correcting unit 65 performing multiplication with the correction coefficient T is illustrated as the “spectrum information after second correction” in FIG. 14.

Step ST61 is a step of selecting the spectrum information indicating the information about the distance to the surface of the adhering substance, and a second correction processing step.

In step ST62, the second spectrum information selecting unit 66 in the information processing unit 6 obtains spectrum information indicating a second peak value P2′ having a value lower than the first peak value P1 with respect to the value of the spectrum information after the second correction obtained in step ST61.

The spectrum information indicating the second peak value P2′ is information (information indicating the distance L2) provisionally indicating the distance to the measurement surface of the measurement target 8, and is indicated in the “spectrum information after second correction” in FIG. 14.

Step ST62 is a second selection processing step that is a step of selecting the spectrum indicating the second peak value P2′.

In step ST63, the distance information acquiring unit 67 in the information processing unit 6 obtains the spectrum information indicating the distance obtained according to the above Expression (5) as the information (information indicating the distance L0) about the distance to the measurement surface of the measurement target 8, using the spectrum information indicating the first peak value P1 obtained in step ST4, the spectrum information indicating the second peak value P2′ obtained in step ST62, and the refractive index of the adhering substance adhering to the measurement surface of the measurement target 8.

The spectrum indicating the information about the distance to the measurement surface of the measurement target 8 is illustrated in the “corrected spectrum information” in FIG. 14.

The spectrum information indicating the distance L0 obtained in step ST63 is output from the output unit 68 as the information about the distance to the measurement surface of the measurement target 8.

Step ST63 is a distance information acquiring step.

On the other hand, when the information processing unit 6 receives the presence information about a step on the measurement surface of the measurement target 8 from the control unit 7, the information processing unit 6 sets the spectrum information indicating the first peak value P1 indicating the highest peak value in the spectrum information after the first correction obtained in step ST4, as the spectrum information indicating the information (information indicating the distance L1) about the distance to the reference surface of the measurement surface of the measurement target 8, as illustrated in the “spectrum information after first correction” in FIG. 15 (step ST71).

The reference surface of the measurement surface of the measurement target 8 is the upper surface of the measurement surface.

Accordingly, the spectrum information indicating the first peak value P1 is spectrum information indicating the information (information indicating the distance L1) about the distance to the upper surface of the measurement surface of the measurement target 8.

In step ST71, the second spectrum information correcting unit 65 in the information processing unit 6 further obtains spectrum information obtained by eliminating the amount of variation of the distance depending on the step on the measurement surface of the measurement target 8 from the spectrum information after the first correction obtained in step ST3, using the information about the step on the measurement surface of the measurement target 8.

That is, in step ST71, the second spectrum information correcting unit 65 obtains the spectrum information after the second correction that has been performed by multiplying the value of the spectrum information after the first correction by the correction coefficient G in which the ratio of the under surface to the upper surface of the step on the measurement surface of the measurement target 8 is a value greater than 1.

The correction coefficient G is the value obtained by multiplying the first correction coefficient Gr by the second correction coefficient Gd.

The first correction coefficient Gr is the value obtained by calculating the first correction coefficient Gr (LD) for the under-side step according to the above Expression (7), where the ratio of the under surface to the upper surface of the step on the measurement surface of the measurement target 8 has a value greater than 1, and the first correction coefficient Gr (LU) for the upper-side step is 1.

Also, the second correction coefficient Gd is the value obtained by calculating the second correction coefficient Gd (LD) for the under-side step according to the above Expression (12), where the ratio of the under surface to the upper surface of the step on the measurement surface of the measurement target 8 has a value greater than 1, and the second correction coefficient Gd (LU) for the upper-side step is 1.

In short, in step ST71, the second spectrum information correcting unit 65 obtains the spectrum information after the second correction performed by multiplying the second correction coefficient Gd by the spectrum information after the second pre-stage correction obtained by multiplying the value of the spectrum information after the first correction by the first correction coefficient Gr.

The spectrum obtained by the second spectrum information correcting unit 65 performing multiplication with the correction coefficient G is illustrated as the “spectrum information after second correction” in FIG. 15.

In the spectrum information after the second correction, when the irradiation point formed on the measurement surface of the measurement target 8 by the measurement light from the irradiation optical system 3 is located at the edge of the step on the measurement surface, the second peak value P2 at which the intensity of the peak of the spectrum in the spectrum information at the under-side step L reaches the maximum value is substantially the same value as the first peak value P1 at which the intensity of the peak of the spectrum in the spectrum information at the upper-side step reaches the maximum value.

Step ST71 is a step of selecting the spectrum information indicating the information about the distance to the upper surface and a second correction processing step.

In step ST72, the second spectrum information selecting unit 66 in the information processing unit 6 obtains the spectrum information indicating the highest peak value P2 at the under-side step L with respect to the value of the spectrum information after the second correction obtained in step ST71.

The spectrum information indicating the second peak value P2 is the distance information (information indicating the distance L2) indicating the distance to the under surface of the measurement surface of the measurement target 8, and is indicated in the “spectrum information after second correction” in FIG. 15.

Step ST72 is a second selection processing step that is a step of selecting the spectrum indicating the second peak value P2.

In step ST73, the distance information acquiring unit 67 in the information processing unit 6 sets the step center or the position of the edge, which is the position in the horizontal direction at which the absolute value P_{diff} of the difference between the first peak value P1 indicated by the spectrum information obtained in step ST4 and the second peak value P2 indicated by the spectrum information obtained in step ST72 indicates a local minimum value, or the position in the X-axis direction in this example, and sets the position information in the horizontal direction corresponding to the spectrum information indicating the first peak value P1 at this point of time as the position information about the edge, which is the additional information.

The position information in the horizontal direction corresponding to the spectrum information indicating the first peak value P1 at which the absolute value P_{diff} indicates a local minimum value as obtained in step ST73 is output from the output unit 68 as edge position information indicating the edge of the step.

Further, the spectrum information indicating the first peak value P1 at which the absolute value P_{diff} indicates a local minimum value is output from the output unit 68 as the information about the distance to the upper surface of the step on the measurement surface of the measurement target 8, and the spectrum information indicating the second peak value P2 at which the absolute value P_{diff} indicates a local minimum value is output from the output unit 68 as the information about the distance to the under surface of the step on the measurement surface of the measurement target 8.

Step ST73 is a step of acquiring the edge position information and the distance information about the step.

In a case where the information processing unit 6 is formed with a PC, the processing steps illustrated in FIG. 13 may be stored at a program in a ROM in the information processing unit 6.

As the programs stored in the ROM, there are three programs of a first program to a third program.

The first program stored in the ROM is “a program for acquiring distance information in an optical measuring device, the program causing a computer to execute: a procedure for obtaining spectrum information by performing Fourier transform on measurement information obtained by performing photoelectric conversion on interfering light obtained by multiplexing reflected light for measurement with reference light formed with swept light, the reflected light for measurement being formed with reflected light of measurement light reflected by a measurement surface of a measurement target, the measurement light being formed with the swept light whose wavelength continuously changes with time; a procedure for obtaining spectrum information from which noise has been eliminated, by comparing the Fourier transformed spectrum information with a threshold for denoising, and eliminating a value of spectrum information lower than the threshold for denoising from the Fourier transformed spectrum information; a procedure for obtaining spectrum information after first correction by eliminating an amount of variation of a distance depending on an irradiation optical system using information regarding a characteristics parameter indicating optical characteristics of the irradiation optical system, from the spectrum information from which noise has been eliminated; a procedure for obtaining spectrum information indicating a first peak value that is a highest peak value with respect to a value of the spectrum information after the first correction; and a procedure for outputting the spectrum information indicating the first peak value as information about a distance to the measurement surface of the measurement target”.

The second program stored in the ROM is “a program for acquiring distance information in an optical measuring device, the program causing a computer to execute: a procedure for obtaining Fourier transformed spectrum information by performing Fourier transform on measurement information obtained by performing photoelectric conversion on interfering light obtained by multiplexing reflected light for measurement with reference light formed with swept light, the reflected light for measurement being formed with reflected light of measurement light reflected by a measurement surface of a measurement target, the measurement light being formed with the swept light whose wavelength continuously changes with time; a procedure for obtaining spectrum information from which noise has been eliminated, by comparing the Fourier transformed spectrum information with a threshold for denoising, and eliminating a value of spectrum information lower than the threshold for denoising from the Fourier transformed spectrum information; a procedure for obtaining spectrum information after first correction by eliminating an amount of variation of a distance depending on an irradiation optical system using information regarding a characteristics parameter indicating optical characteristics of the irradiation optical system, from the spectrum information from which noise has been eliminated; a procedure for obtaining spectrum information indicating a first peak value that is a highest peak value with respect to a value of the spectrum information after the first correction; a procedure for obtaining spectrum information after second correction in which an amount of variation of a distance depending on an adhering substance on the measurement target has been eliminated from the spectrum information after the first correction, using information about the adhering substance adhering to the measurement surface of the measurement target; a procedure for obtaining spectrum information indicating a second peak value having a value lower than the first peak value with respect to a value of the spectrum information after the second correction; a procedure for obtaining information about a distance to the measurement surface of the measurement target, the information about the distance being spectrum information indicated by a value obtained by adding a value obtained by dividing a subtraction value by a refractive index of the adhering substance to a value of the distance information formed with the spectrum information indicated by the first peak value, the subtraction value being obtained by subtracting a value of the distance information formed with the spectrum information indicated by the first peak value from a value of distance information formed with spectrum information indicated by the second peak value; and a procedure for outputting the information about the distance to the measurement surface of the measurement target”.

The third program stored in the ROM is “a program for acquiring edge position information in an optical measuring device, the program causing a computer to execute: a procedure for obtaining Fourier transformed spectrum information by performing Fourier transform on measurement information obtained by performing photoelectric conversion on interfering light obtained by multiplexing reflected light for measurement with reference light formed with swept light, the reflected light for measurement being formed with reflected light of measurement light reflected by a measurement surface of a measurement target, the measurement light being formed with the swept light whose wavelength continuously changes with time; a procedure for obtaining spectrum information from which noise has been eliminated, by comparing the Fourier transformed spectrum information with a threshold for denoising, and eliminating a value of spectrum information lower than the threshold for denoising from the Fourier transformed spectrum information; a procedure for obtaining spectrum information after first correction by eliminating an amount of variation of a distance depending on an irradiation optical system using information regarding a characteristics parameter indicating optical characteristics of the irradiation optical system, from the spectrum information from which noise has been eliminated; a procedure for obtaining spectrum information indicating a first peak value that is a highest peak value with respect to a value of the spectrum information after the first correction; a procedure for obtaining spectrum information after second correction in which an amount of variation of a distance depending on an upper surface and an under surface of a step on measurement surface of the measurement target has been eliminated from the spectrum information after the first correction, using a correction coefficient in which a ratio of the under surface to the upper surface of the step on the measurement surface of the measurement target is a value greater than 1; a procedure for obtaining spectrum information indicating a second peak value that is a highest peak value with respect to a value of spectrum information located at the under surface of the step on the measurement target, in the spectrum information after the second correction; a procedure for obtaining additional information indicating a position of the step on the measurement surface of the measurement target, the position of the step being a position of emission of the measurement light from the irradiation optical system, at which a difference between the first peak value indicated by the spectrum information indicating the first peak value and the second peak value indicated by the spectrum information indicating the second peak value indicates a smallest value; and a procedure for outputting the additional information indicating the position of the step on the measurement surface of the measurement target”.

The optical measuring device according to the first embodiment is an optical measuring device of a wavelength scanning interference type using a SS-OCT, and obtains spectrum information by performing Fourier transform on measurement information obtained by performing photoelectric conversion on interfering light obtained by multiplexing reflected light for measurement and reference light formed with swept light, the reflected light for measurement being formed with reflected light of measurement light reflected by a measurement surface of a measurement target, the measurement light being formed with the swept light whose wavelength continuously changes with time. The information processing unit 6 corrects the obtained spectrum information using variable factor information for measurement of the distance to the measurement surface of the measurement target, and obtains information about the distance to the measurement surface of the measurement target on the basis of the corrected spectrum information. Thus, the distance to the measurement surface of the measurement target can be measured with high accuracy.

In the optical measuring device according to the first embodiment, the information processing unit 6 includes the denoising processing unit 62, the first spectrum information correcting unit 63, the first spectrum information selecting unit 64, and the output unit 68. The information processing unit 6 obtains spectrum information from which noise has been eliminated from the Fourier transformed spectrum information, obtains spectrum information after first correction from which the amount of variation of the distance depending on the irradiation optical system has been eliminated from the spectrum information from which noise has been eliminated, obtains spectrum information indicating the first peak value that is the highest peak value with respect to the value of the spectrum information after the first correction, and outputs the spectrum information indicating the first peak value as the information about the distance to the measurement surface of the measurement target 8. Thus, when the measurement target has no unique information on the measurement surface, such as presence information about an adhering substance and presence information about a step on the measurement surface of the measurement target 8, the distance to the measurement surface of the measurement target 8 can be accurately performed, without being affected by harmonics due to resampling, false signal noise such as side lobes, and the amount of variation of the distance depending on the irradiation optical system.

In the optical measuring device according to the first embodiment, the information processing unit 6 includes the second spectrum information correcting unit 65, the second spectrum information selecting unit 66, the distance information acquiring unit 67, and the output unit 68. When there is information about an adhering substance adhering to the measurement surface of the measurement target 8, the information processing unit 6 obtains the spectrum information after the second correction in which the amount of variation of the distance depending on the adhering substance has been eliminated from the spectrum information after the first correction, obtains the spectrum information indicating the second peak value having a value lower than the first peak value with respect to the value of the spectrum information after the second correction, and obtains and outputs the information about the distance to the measurement surface of the measurement target 8, the information about the distance being the spectrum information indicated by the value obtained by adding the value obtained by dividing the subtraction value obtained by subtracting the value of the distance information formed with the spectrum information indicated by the first peak value from the value of the distance information formed with the spectrum information indicated by the second peak value by the refractive index of the adhering substance, to the value of the distance information formed with the spectrum information indicated by the first peak value. Thus, the rate of detection of the spectrum information indicating the second peak value on the measurement surface of the measurement target 8 to which the adhering substance adheres can be increased, and the distance to the measurement surface of the measurement target 8 can be detected with high accuracy.

In the optical measuring device according to the first embodiment, the information processing unit 6 includes the second spectrum information correcting unit 65, the second spectrum information selecting unit 66, the distance information acquiring unit 67, and the output unit 68. When there is information on a step on the measurement surface of the measurement target 8, the information processing unit 6 obtains the spectrum information after the second correction in which the amount of variation of the distance depending on the upper surface and the under surface of the step has been eliminated from the spectrum information after the first correction, obtains the spectrum information indicating the second peak value located at the under surface of the step on the measurement target 8 in the spectrum information after the second correction, and obtains and outputs the additional information indicating the position of the step on the measurement surface of the measurement target, the additional information being the position of emission of the measurement light from the irradiation optical system 3 at which the difference between the first peak value indicated by the spectrum information indicating the first peak value and the second peak value indicated by the spectrum information indicating the second peak value indicates the smallest value. Thus, the step can be detected with a higher resolution than the spatial resolution determined by the spot diameter of the measurement light from the irradiation optical system 3, and the position of the edge on the measurement surface of the measurement target 8 can be accurately identified.

### Second Embodiment

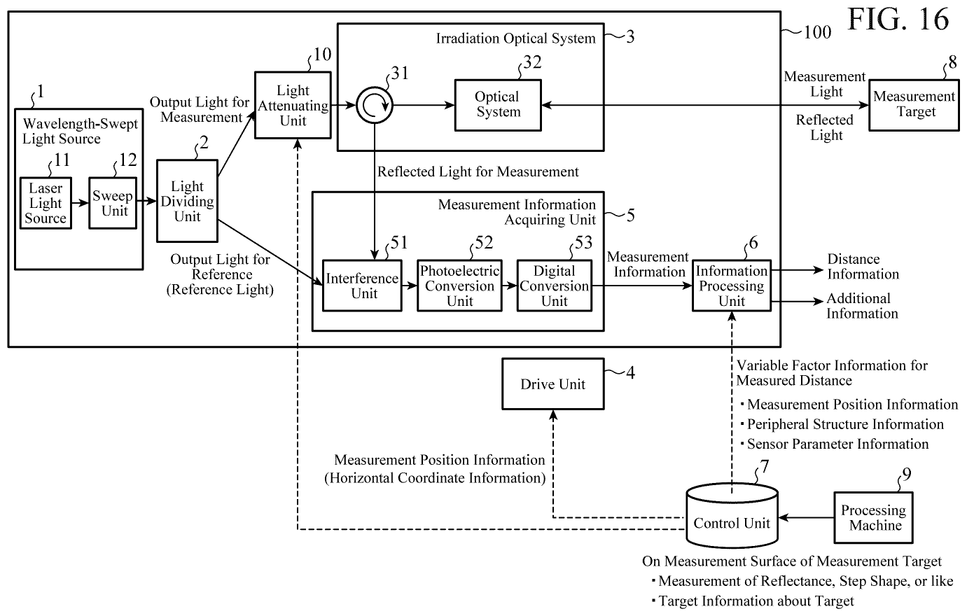

An optical measuring device according to a second embodiment is described with reference to FIG. 16.

The optical measuring device according to the second embodiment differs from the optical measuring device according to the first embodiment in that a light attenuating unit 10 that reduces the amount of light in the output light for measurement from the light dividing unit 2 is disposed in the path of the output light for measurement from the light dividing unit 2 to the optical circulator 31 in the irradiation optical system 3, and the other aspects are the same as those of the first embodiment.

Note that, in FIG. 16, the same reference numerals as those in FIG. 1 denote the same or corresponding portions.

In the optical measuring device according to the second embodiment, the light attenuating unit 10 that outputs the amount of light in the output light for measurement from the light dividing unit 2, which is the output light for measurement formed with swept light from the wavelength-swept light source, as the output light for measurement having the light amount reduced by a set attenuation level to the optical circulator 31 in the irradiation optical system 3 is provided in the optical measuring device according to the first embodiment, and, hereinafter, the light attenuating unit 10 different from the optical measuring device according to the first embodiment will be mainly described.

The light attenuating unit 10 is a generally known optical device for adjusting the intensity of optical power level.

The set attenuation level in the light attenuating unit 10 is a value ATT that determines the reception power Pr [w] of the reflected light received by the irradiation optical system 3 to be smaller than a light saturation threshold PTH [w] in the measurement information acquiring unit 5.

The reception power Pr and the light saturation threshold PTH have the relationship shown in Expression (14) below, and the reception power Pr and the set attenuation level ATT have the relationship shown in Expression (15) below.

$$Pr < {P}_{TH} \times γ \qquad ( 14 )$$

$$Pr ( L ) ∝ {P}_{T} {η}_{sys} {η}_{F} \frac{\frac{π {D}^{2}}{4} exp ( - 2 \int α ( L ) dL ) R ( L ) V ( L )}{{L}^{2} ( 1 + ( \frac{π {D}^{2}}{4 λ L} ) {( 1 - \frac{L}{F} )}^{2} )} \times ATT \qquad ( 15 )$$

In Expression (14), y represents the margin, and is set to 0.8 in terms of likelihood, for example.

In Expression (15), PT represents the transmission power [w] of the measurement light emitted from the optical system 32 in the irradiation optical system 3, ηsys represents the efficiency of the system, η_{F} represents the coupling efficiency in the far field, L represents the distance [m] to the measurement surface of the measurement target 8, F represents the light-condensing distance [m] by the optical system 32, D represents the aperture diameter [m] of the lens of the optical system 32, α(L) represents the dissipation factor (1-transmittance) [/μm] with respect to the distance L, R(L) represents the reflectance with respect to the distance L, V(L) represents the area ratio with respect to the distance L, and A represents the center frequency of wavelength in the sweep range in the swept light.

That is, the set attenuation level ATT is the value that determines the reception power Pr(L) satisfying Expression (14), according to Expression (15).

The calculation according to Expressions (14) and (15) is performed by the control unit 7, and a control signal indicating the set attenuation level ATT that is a result of the calculation by the control unit 7 is supplied to the light attenuating unit 10.

As the light attenuating unit 10 is designed in this manner, even if the reception power Pr(L) of the reflected light received by the irradiation optical system 3 fluctuates due to the reflectance on the measurement surface of the measurement target 8, the reception power Pr(L) of the reflected light does not exceed the light saturation threshold PTH in the measurement information acquiring unit 5, and saturation of the measurement information in the measurement information acquiring unit 5 can be prevented.

Note that the set attenuation level in the light attenuating unit 10 may be set on the basis of the voltage range of a device that is a bottleneck in the measurement information acquiring unit 5, such as the digital conversion unit 53.

In this case, the set attenuation level in the light attenuating unit 10 is determined to be a value at which the amount of light in the reflected light for measurement from the irradiation optical system 3 for obtaining the measurement information falls within the power range of the digital conversion unit.

Also, the set attenuation level in the light attenuating unit 10 may be set on the basis of the amount of light in the reflected light for measurement that is input from the irradiation optical system 3 to the interference unit 51.

In this case, the set attenuation level in the light attenuating unit 10 is determined to be a value at which the amount of light in the reflected light for measurement that is input from the irradiation optical system 3 to the interference unit 51 is lower than the light amount saturation threshold in the measurement information acquiring unit 5.

Operations in the optical measuring device according to the second embodiment are now described.

The amount of light in the output light for measurement obtained by the light dividing unit 2 dividing the swept light from the wavelength-swept light source 1 is reduced by the light attenuating unit 10 having the set attenuation level ATT determined by the control signal indicating the set attenuation level ATT from the control unit 7, which is less than 1, and the reduced output light for measurement is emitted as the measurement light toward the measurement surface of the measurement target 8 by the irradiation optical system 3.

On the other hand, when the control signal is a control signal indicating the set attenuation level ATT of 1 from the control unit 7, the light attenuating unit 10 outputs the amount of light in the output light for measurement divided by the light dividing unit 2 to the irradiation optical system 3 without any change.

The subsequent operations are the same as the operations in the optical measuring device according to the first embodiment, and therefore, explanation thereof is not made herein.

The optical measuring device according to the second embodiment also has the same effects as those of the optical measuring device according to the first embodiment. Furthermore, even if the reception power Pr(L) of the reflected light received by the irradiation optical system 3 varies depending on the reflectance on the measurement surface of the measurement target 8, saturation of the measurement information in the measurement information acquiring unit 5 can be prevented, and the distance to the measurement surface of the measurement target 8 can be detected with high accuracy.

Note that it is possible to freely combine the respective embodiments, modify any of the components of the respective embodiments, or omit any of the components in the respective embodiments.

### INDUSTRIAL APPLICABILITY

An optical measuring device according to the present disclosure is suitable for an optical measuring device that measures a distance to a measurement target in a processing apparatus and a semiconductor inspection apparatus.

### REFERENCE SIGNS LIST

1: wavelength-swept light source, 2: light distributing unit, 3: irradiation optical system, 4: drive unit, 5: measurement information acquiring unit, 51: interference unit, 52: photoelectric conversion unit, 53: digital conversion unit, 6: information processing unit, 61: FFT processing unit, 62: denoising processing unit, 63: first spectrum information correcting unit, 64: first spectrum information selecting unit, 65: second spectrum information correcting unit, 66: second spectrum information selecting unit, 67: distance information acquiring unit, 68: output unit, 7: control unit, 8: measurement target, 10: light attenuating unit

The invention claimed is:

1. An optical measuring device comprising:
a wavelength-swept light source to output swept light whose wavelength continuously changes with time;
an irradiation optical system to emit output light for measurement formed with the swept light from the wavelength-swept light source as measurement light in a space toward a measurement surface of a measurement target, receive reflected light of the measurement light reflected by the measurement surface of the measurement target, and output the reflected light as reflected light for measurement;
a reference light path to output output light for reference as reference light formed with the swept light from the wavelength-swept light source;
a measurement information acquirer to multiplex the reflected light for measurement from the irradiation optical system and the reference light from the reference light path, and output measurement information obtained by photoelectrically converting the multiplexed interfering light; and
an information processor including: a spectrum acquirer to obtain spectrum information by performing Fourier transform on the measurement information from the measurement information acquirer; a denoising processor to compare a denoising threshold with a value of the spectrum information obtained by the spectrum acquirer and obtain the spectrum information from which a noise is removed; a second spectrum information corrector to obtain the spectrum information from which a variation value of a distance depending on a step of the measurement target using a correction coefficient whose ratio of an under surface to a upper surface forming the step having a height difference at an measurement surface of the measurement target, is larger than 1 is removed from the spectrum information obtained by the denoising processor; a second spectrum information selector to obtain the spectrum information indicating a second peak value which is a different spectrum information from the spectrum information indicating a first peak value which is a highest peak value in the spectrum information obtained by the denoising processor for the spectrum information obtained by the second spectrum information corrector; a distance information acquirer to obtain as an additional information indicating the step at the measurement surface of the measurement target, a emitting position of the measurement light from the irradiation optical system, the difference between the first peak value and the second peak value indicated by the spectrum information selected by the second spectrum information selector indicating minimum; and an outputter to output the additional information indicating a position of the step at the measurement surface of the measurement target obtained by the distance information acquirer.

2. The optical measuring device according to claim 1, further comprising a light attenuator to output, to the irradiation optical system, an amount of light in the output light for measurement formed with the swept light from the wavelength-swept light source as output light for measurement having the amount of light reduced by a set attenuation level.

3. The optical measuring device according to claim 2, wherein the set attenuation level is a value for determining reception power of reflected light received by the irradiation optical system to be lower than a light saturation threshold in the measurement information acquirer.

4. The optical measuring device according to claim 2, wherein
the measurement information acquirer includes: an interferencer to multiplex the reflected light for measurement from the irradiation optical system and the reference light from the reference light path; a photoelectric converter to photoelectrically convert interfering light multiplexed by the interferencer; and a digital converter to convert an analog signal from the photoelectric converter into a digital signal, and output the digital signal as measurement information, and
the set attenuation level is determined to be a value at which an amount of light in the reflected light for measurement from the irradiation optical system for obtaining the measurement information falls within a power range of the digital converter.

5. An optical measuring device, comprising:
a wavelength-swept light source to output swept light whose wavelength continuously changes with time;
an irradiation optical system to emit output light for measurement formed with the swept light from the wavelength-swept light source as measurement light in a space toward a measurement surface of a measurement target, receive reflected light of the measurement light reflected by the measurement surface of the measurement target, and output the reflected light as reflected light for measurement;
a reference light path to output output light for reference as reference light formed with the swept light from the wavelength-swept light source;
a measurement information acquirer to multiplex the reflected light for measurement from the irradiation optical system and the reference light from the reference light path, and output measurement information obtained by photoelectrically converting the multiplexed interfering light; and
an information processor including:
a spectrum acquirer to obtain spectrum information by performing Fourier transform on the measurement information from the measurement information acquirer;
a denoising processor to obtain spectrum information from which noise has been eliminated, by comparing a value of the spectrum information obtained by the spectrum acquirer with a threshold for denoising;
a first spectrum information corrector to obtain spectrum information in which an amount of variation of a distance depending on the irradiation optical system has been eliminated from the spectrum information obtained by the denoising processor, using information regarding the characteristics parameter indicating optical characteristics of the irradiation optical system;
a first spectrum information selector to obtain spectrum information indicating a first peak value that is a highest peak value with respect to a value of the spectrum information obtained by the first spectrum information corrector;
a second spectrum information corrector to obtain the spectrum information from which a variation value of a distance depending on a step of the measurement target using a correcting coefficient whose ratio of an under surface to a upper surface forming the step having a height difference at an measurement surface of the measurement target, is larger than 1 is removed from the spectrum information obtained by the first spectrum information corrector;
a second spectrum information selector to obtain the spectrum information indicating a second peak value being a highest peak value with respect to a value of the spectrum information, positioned at a under surface at the step of the measurement target obtained by the second spectrum information corrector;
a distance information acquirer to obtain as an additional information indicating the step position at the measurement surface of the measurement target, a emitting position of the measurement light from the irradiation optical system, the difference between the first peak value indicated by the spectrum information selected by the first spectrum information selector and the second peak value indicated by the spectrum information selected by the second spectrum information selector indicating minimum; and
an outputter to output the additional information indicating a position of the step at the measurement surface of the measurement target obtained by the distance information acquirer.

6. The optical measuring device according to claim 5, further comprising: an optical attenuator to output to the irradiation optical system as output light for measurement of an optical amount reduced by a set attenuation level, the optical amount of the output light for measurement by swept light from the wavelength swept light source.

7. The optical measuring device according to claim 6, wherein the set attenuation level is determined so that reception power of the reflected light received by the irradiation optical system to be below optical saturation threshold at the measurement information acquirer.

8. The optical measuring device according to claim 6, wherein
the measurement information acquirer comprising: an interferencer multiplexing the reflected light for measurement from the irradiation optical system and a reference light from the reference optical path; a photoelectrical converter to photoelectrically convert the interference light multiplexed by the interferencer; and a digital converter to output as information for measurement analog-to-digital converted signal from the photoelectrically converter,
wherein the set attenuation level is determined so that the optical amount of the reflected light for measurement from the irradiation optical system for obtaining the information for measurement is within a power range of the digital converter.

9. A method for acquiring edge position information in an optical measuring device, the method comprising:
obtaining spectrum information by performing Fourier transform on measurement information obtained by performing photoelectric conversion on interfering light obtained by multiplexing reflected light for measurement and reference light, the reflected light for measurement being formed with reflected light of measurement light reflected by a measurement surface of a measurement target, the measurement light being formed with swept light whose wavelength continuously changes with time, the reference light being formed with the swept light;
obtaining spectrum information from which noise has been eliminated, by comparing the spectrum information obtained with a threshold for denoising, and eliminating a value of the spectrum information lower than the threshold for denoising;
obtaining spectrum information in which an amount of variation of a distance depending on an irradiation optical system using information related to a characteristics parameter indicating optical characteristics of the irradiation optical system has been eliminated from the spectrum information obtained;
obtaining spectrum information indicating a first peak value that is a highest peak value with respect to a value of the spectrum information obtained;
obtaining spectrum information in which an amount of variation of a distance depending on an upper surface and an under surface of a step on the measurement surface of the measurement target has been eliminated using a correction coefficient in which a ratio of the under surface to the upper surface of the step on the measurement surface of the measurement target is a value greater than 1, from the spectrum information obtained;
obtaining spectrum information indicating a second peak value that is a highest peak value with respect to a value of the spectrum information located at the under surface of the step on the measurement target;
obtaining additional information indicating a position of the step on the measurement surface of the measurement target, the position indicated by the additional information being a position of emission of the measurement light from the irradiation optical system at which a difference between the first peak value indicated by the spectrum information selected and the second peak value indicated by the spectrum information selected indicates a smallest value; and
outputting the additional information indicating the position of the step on the measurement surface of the measurement target, the additional information having been obtained.

10. A recording medium storing a program for acquiring edge position information in an optical measuring device, the program causing a computer to execute:
obtaining Fourier transformed spectrum information by performing Fourier transform on measurement information obtained by performing photoelectric conversion on interfering light obtained by multiplexing reflected light for measurement and reference light, the reflected light for measurement being formed with reflected light of measurement light reflected by a measurement surface of a measurement target, the measurement light being formed with the swept light whose wavelength continuously changes with time, the reference light being formed with the swept light;
obtaining spectrum information from which noise has been eliminated, by comparing the Fourier transformed spectrum information with a threshold for denoising, and eliminating a value of the spectrum information lower than the threshold for denoising from the Fourier transformed spectrum information;
obtaining spectrum information after first correction by eliminating an amount of variation of a distance depending on an irradiation optical system using information related to a characteristics parameter indicating optical characteristics of the irradiation optical system, from the spectrum information from which noise has been eliminated;
obtaining spectrum information indicating a first peak value that is a highest peak value with respect to a value of the spectrum information after the first correction;
obtaining spectrum information after second correction in which an amount of variation of a distance depending on an upper surface and an under surface of a step on measurement surface of the measurement target has been eliminated from the spectrum information after the first correction, using a correction coefficient in which a ratio of the under surface to the upper surface of the step on the measurement surface of the measurement target is a value greater than 1;
obtaining spectrum information indicating a second peak value that is a highest peak value with respect to a value of spectrum information located at the under surface of the step on the measurement target, in the spectrum information after the second correction;
obtaining additional information indicating a position of the step on the measurement surface of the measurement target, the position of the step being a position of emission of the measurement light from the irradiation optical system, at which a difference between the first peak value indicated by the spectrum information indicating the first peak value and the second peak value indicated by the spectrum information indicating the second peak value indicates a smallest value; and
outputting the additional information indicating the position of the step on the measurement surface of the measurement target.
